(19) United States
(12) Patent Application Publication
(10) Pub. No.: US 2018/0209877 A1
(43) Pub. Date: Jul. 26, 2018

(54) SEED GRINDER AND CONSUMABLE FOR SEED GRINDER

(71) Applicant: DOUGLAS SCIENTIFIC, LLC, ALEXANDRIA, MN (US)

(72) Inventors: JACOB P. HENDRICKX, CAMPBELL, MN (US); CHAD S. SMITH, BATTLE LAKE, MN (US); HANS A. MISCHE, GREY EAGLE, MN (US); MICHAEL BOTZET, GARFIELD, MN (US)

(73) Assignee: DOUGLAS SCIENTIFIC, LLC, ALEXANDRIA, MN (US)

(21) Appl. No.: 15/576,212

(22) PCT Filed: May 26, 2016
(86) PCT No.: PCT/US16/34390

§ 371 Date: Nov. 21, 2017

Related U.S. Application Data
(60) Provisional application No. 62/166,297, filed on May 26, 2015.
(60) Provisional application No. 62/307,215, filed on Mar. 11, 2016.

(51) Int. Cl. G01N 1/28; G01N 1/38; G01N 1/40; B02C 18/10; B02C 18/16; B02C 23/16; B01D 15/00

(52) U.S. Cl. CPC G01N 1/286; G01N 1/38; G01N 1/4077; B02C 18/10; B02C 2023/165; B02C 23/16; B01D 15/00; G01N 2001/2866; G01N 2001/4088; B02C 18/16

(57) ABSTRACT

A seed grinder includes a housing that is configured to contain seeds and a buffer solution, a grinding mechanism that is positionable in the housing to grind the seeds in the housing, and a dispensing mechanism attached to the housing and configured to dispense the ground seeds and the buffer solution from the housing into a sample holder.

### CROSS-REFERENCE TO RELATED APPLICATION(S)

This application claims priority to U.S. Provisional Application No. 62/166,297, filed on May 26, 2015, and entitled “Seed Grinder,” the disclosure of which is incorporated by reference in its entirety, and to U.S. Provisional Application No. 62/307,215, filed on Mar. 11, 2016, and entitled “Seed Grinder,” the disclosure of which is incorporated by reference in its entirety.

### BACKGROUND

The present invention relates to a seed grinder, and in particular, to a seed grinder for grinding and dispensing seeds.

Seeds can be broken up prior to testing the seed using polymerize chain reaction methods, immunoassay methods, or a variety of other testing methods. Seeds that are collected are stored and transported in a sealed container. The seeds are then transferred from the sealed container to a seed grinder. The seed grinder can grind the seeds. The ground seeds can then be removed from the seed grinder and placed in a mixing container. In the mixing container, the ground seeds can be mixed with a buffer solution to form a seed and buffer solution mixture. The seed and buffer solution mixture can then be transferred from the mixing container to a sample holder for testing. The sample holder can include a single tube, a tube array, a micro plate, a profile belt, a tape, a pipette tip, a plurality of pipettes, or any other suitable sample holder.

Preparing a seed sample for testing in this manner requires numerous pieces of equipment and numerous containers to prepare a seed and buffer solution mixture. There is a risk of contamination each time the seeds and the seed and buffer solution mixture are transferred between different containers and pieces of equipment. Contamination can result in inaccurate testing results when the seed and buffer solution mixture are tested. Further, it can take up a lot of space to store all of the equipment and containers needed to prepare the seed and buffer solution mixture for testing.

### SUMMARY

A seed grinder includes a housing that is configured to contain seeds and a buffer solution, a grinding mechanism that is positionable in the housing to grind the seeds in the housing, and a dispensing mechanism attached to the housing and configured to dispense the ground seeds and the buffer solution from the housing into a sample holder.

### BRIEF DESCRIPTION OF THE DRAWINGS

FIG. 1 is a side view of a first embodiment of a seed grinder.

FIG. 2 is a side view of the first embodiment of the seed grinder shown in FIG. 1 dispensing a seed and buffer solution mixture into a card consumable with a dispensing mechanism.

FIG. 3A is a partial cross-sectional side view of a second embodiment of a seed grinder.

FIG. 3B is a partial cross-sectional side view of the second embodiment of the seed grinder shown in FIG. 3A when a grinding mechanism is positioned to grind seeds.

FIG. 3C is a partial cross-sectional side view of the second embodiment of the seed grinder shown in FIG. 3A when a dispensing mechanism is positioned to dispense a seed and buffer solution mixture.

FIG. 4A is a partial cross-sectional side view of the second embodiment of the seed grinder dispensing a seed and buffer solution mixture into a card consumable using a first configuration.

FIG. 4B is a partial cross-sectional side view of the second embodiment of the seed grinder dispensing a seed and buffer solution mixture into a card consumable using a second configuration.

FIG. 4C is a partial cross-sectional side view of the second embodiment of the seed grinder dispensing a seed and buffer solution mixture into a card consumable using a third configuration.

FIG. 5A is a partial cross-sectional side view of a third embodiment of a seed grinder.

FIG. 5B is a partial cross-sectional side view of the third embodiment of the seed grinder when a first grinding mechanism is positioned to grind seeds and a second grinding mechanism is positioned to be washed.

FIG. 6A is a side cross-sectional view of a first embodiment of a cup consumable.

FIG. 6B is an exploded view of the cup consumable of FIG. 6A.

FIG. 6C is an isometric view of the cup consumable of FIG. 6A when an aspirate cup has been removed from the cup consumable.

FIG. 6D is a side cross-sectional view of an alternate configuration of the first embodiment of the cup consumable of FIG. 6A.

FIG. 7A is an isometric view of a second embodiment of a cup consumable.

FIG. 7B is an exploded view of the second embodiment of the cup consumable of FIG. 7A.

FIG. 7C is a side cross-sectional view of the second embodiment of the cup consumable of FIG. 7A.

FIG. 8A is an isometric view of a filter tube.

FIG. 8B is an exploded view of the filter tube of FIG. 8A.

FIG. 8C is a cross-sectional view of the filter tube of FIG. 8A.

FIG. 8D is a cross-sectional view of an alternate configuration of filter tube of FIG. 8A.

FIG. 9A is an isometric view of a third embodiment of a cup consumable.

FIG. 9B is an exploded view of the third embodiment of the cup consumable of FIG. 9A.

FIG. 9C is a sectioned isometric view of the third embodiment of the cup consumable of FIG. 9A.

FIG. 9D is a cross-sectional view of the third embodiment of the cup consumable of FIG. 9A.

FIG. 10A is an isometric view of a fourth embodiment of the cup consumable.

FIG. 10B is a sectioned isometric view of the fourth embodiment of the cup consumable of FIG. 10A.

FIG. 11A is an isometric view of a fourth embodiment of a seed grinder.

FIG. 11B is a sectioned isometric view of the fourth embodiment of the seed grinder.

FIG. 11C is an exploded side view of the fourth embodiment of the seed grinder.

FIG. 11D is an exploded isometric view of the fourth embodiment of the seed grinder.

FIG. 12 is a sectioned isometric view of the fourth embodiment of the seed grinder dispensing a sample into a card consumable.

### DETAILED DESCRIPTION

Seed grinders and cup consumables are provided that are capable of grinding seeds, mixing ground seeds with a buffer solution to form a seed and buffer solution mixture, filtering the seed and buffer solution mixture, and dispensing the seed and buffer solution mixture into a sample holder for testing.

### Seed Grinder 100

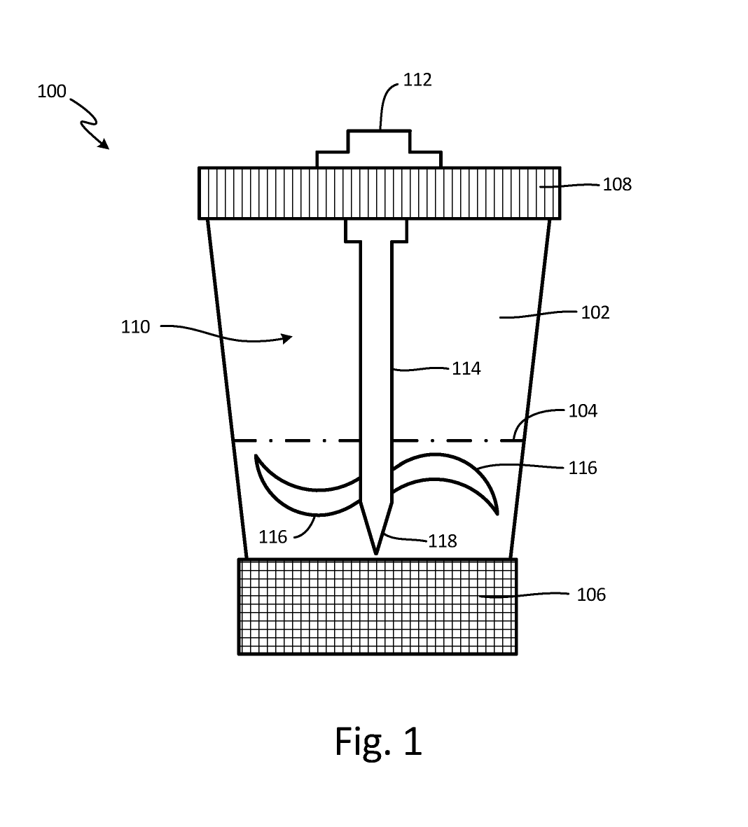

FIG. 1 is a side view of seed grinder 100, which includes cup 102, fill line 104, filter 106, lid 108, and grinding mechanism 110. Grinding mechanism 110 includes motor connection port or coupling 112, shaft 114, blades 116, and drill head 118.

Seed grinder 100 includes cup 102 that forms a body portion of seed grinder 100. Cup 102 includes fill line 104 on cup 102 to indicate how many seeds should be placed in cup 102. Cup 102 can be used to scope up seeds. Cup 102 includes a bottom rim to which filter 106 can be attached. In one embodiment, filter 106 can be attached to cup 102 with a screw mechanism. In alternate embodiments, filter 106 can be attached to cup 102 with any suitable mechanism, including a permanent attachment between filter 106 and cup 102. Cup 102 also includes a top rim to which lid 108 can be attached. In one embodiment, lid 108 can be attached to cup 102 with a screw mechanism. In alternate embodiments, lid 108 can be attached to cup 102 with any suitable mechanism that allows lid 108 to be attached and detached to cup 102.

Grinding mechanism 110 is attached to lid 108 and extends through lid 108. Grinding mechanism 110 includes motor connection port 112, shaft 114, blades 116, and drill head 118. Motor connection port 112 is on a top side of lid 108 and allows a motor to engage motor connection port 112. Motor connection port 112 is connected to a first end of shaft 114. Blades 116 are connected to a second end of shaft 114. In the embodiment shown in FIG. 1, there are two blades 116 connected to shaft 114. Blades 116 can include any suitable number of blades in alternate embodiments and blades 116 can be connected to shaft 114 in any suitable manner. Drill head 118 is also connected to the second end of shaft 114. When a motor engages motor connection port 112 it will rotate shaft 114, which in turn will rotate blades 116 to grind seeds in cup 102. In alternate embodiments, a motor can be permanently attached to motor connection port 112 of grinding mechanism 110.

Seed grinder 100 can be used to grind seeds. Seeds can be placed in cup 102 or cup 102 can be used to scoop up seeds. Cup 102 can be filled with seeds up to fill line 104. Filter 106 can be attached to the bottom of cup 102 and lid 108, including grinding mechanism 110, can be connected to the top of cup 102. A motor can then engage motor connection port 112 of grinding mechanism 110. Once the motor is turned on, shaft 114 will rotate with motor connection port 112, causing blades 116 to rotate in cup 102 and grind the seeds in cup 102. After the seeds are ground and have achieved a homogenous grind, a buffer solution can be added to cup 102 through grinding mechanism 110 to form a seed and buffer solution mixture. Alternatively, lid 108 can be removed from cup 102 and a buffer solution can be dispensed into cup 102. After the buffer solution is added to cup 102, the seeds and the buffer solution can be ground further with grinding mechanism 110 until a desired consistency is achieved, forming a seed and buffer solution mixture. Grinding mechanism 110 can then be actuated down by the motor that is attached to motor connection port 112 while grinding mechanism 110 is being rotated. This will cause drill head 118 of grinding mechanism 110 to perforate and drill a hole into filter 106. The seed and buffer solution mixture can then drain out of cup 102 through filter 106.

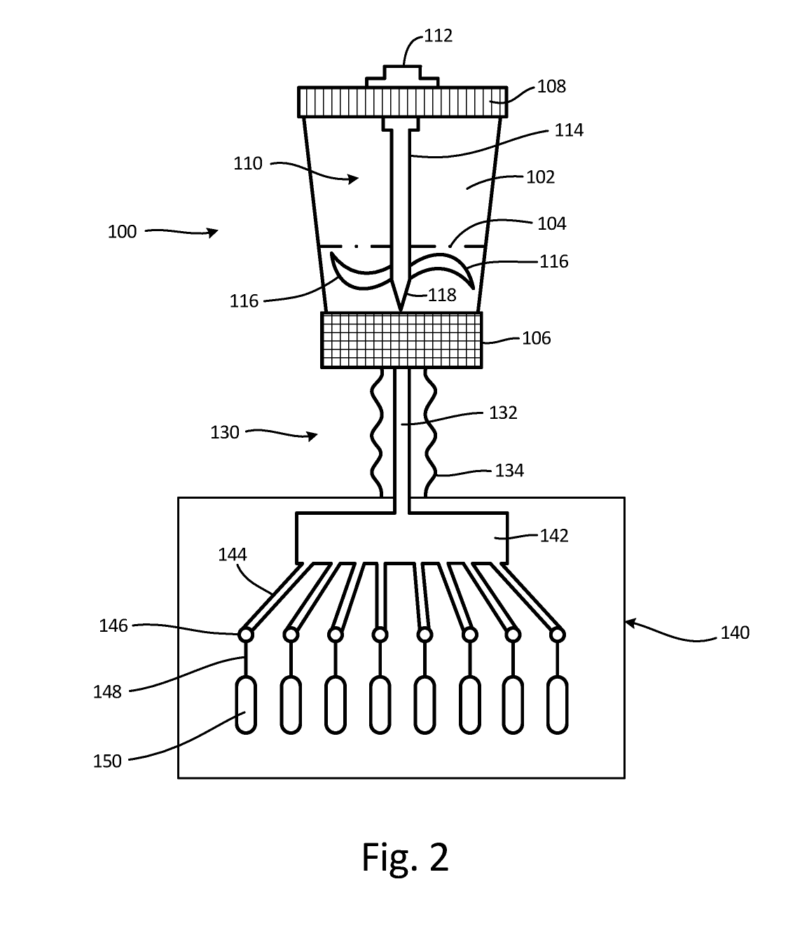

FIG. 2 is a side view of seed grinder 100 dispensing a seed and buffer solution mixture into card consumable 140 with dispensing mechanism 130. Seed grinder 100 includes cup 102, fill line 104, filter 106, lid 108, and grinding mechanism 110. Grinding mechanism 110 includes motor connection port 112, shaft 114, blades 116, and drill head 118. Dispensing mechanism 130 includes vacuum straw 132 and heat source 134. Card consumable 140 includes vacuum chamber 142, first channels 144, reaction chambers 146, second channels 148, and assay chambers 150.

Seed grinder 100 is used to grind seeds as described in reference to FIG. 1 above. Further, a buffer solution can be added to cup 102 of seed grinder 100 after the seeds have been ground. After the seeds are ground and mixed with a buffer solution to form a seed and buffer solution mixture, grinding mechanism 110 is actuated downwards with a motor so that drill head 118 of grinding mechanism 110 perforates and forms a hole in filter 106. The seed and buffer solution mixture can then flow through filter 106 and out of seed grinder 100.

Dispensing mechanism 130 extends between seed grinder 100 and card consumable 140 and dispenses the seed and buffer solution mixture from seed grinder 100 into card consumable 140. Dispensing mechanism 130 includes vacuum straw 132 and heat source 134. A first end of vacuum straw 132 is connected to a bottom of filter 106 of seed grinder 100. A second end of vacuum straw 132 is connected to card consumable 140. Vacuum straw 132 pulls the seed and buffer solution mixture out of seed grinder 100 with suction. Heat source 134 surrounds vacuum straw 132 to maintain the temperatures of the seed and buffer solution mixture while the seed and buffer solution mixture moves through vacuum straw 132. In an alternate embodiment, a tube can connect seed grinder 100 to card consumable 140. An air pressure source or a syringe action can be used to force the seed and buffer solution mixture out of seed grinder 100, through the tube, and into card consumable 140.

The seed and buffer solution mixture will enter into vacuum chamber 142 of card consumable 140 from vacuum straw 132. The seed and buffer solution mixture will then flow through first channels 144 into first reaction chambers 146. In first reaction chambers 146, the seed and buffer solution mixture will mix with a reagent mixture to prepare the seed and buffer solution mixture for testing. The seed and reagent mixture will then flow through second channels 148 into assay chambers 150. When the seed and reagent mixture is in assay chambers 150, card consumable 140 can be inserted into a testing device. In the embodiment shown in FIG. 2, there are eight first channels 144, first reactions chambers 146, second channels 148, and assay chambers 150. In alternate embodiments, card consumable 140 can include any suitable number of first channels 144, first reactions chambers 146, second channels 148, and assay chambers 150. In further alternate embodiments, card consumable 140 can be a single tube, a tube array, a micro plate, a profile belt, a tape, a pipette tip, a plurality of pipettes, or any other suitable sample holder.

Seed grinder 100 allows a seed to be collected, ground, mixed with a buffer solution, filtered, and dispensed all from a single device. Grinding the seeds, mixing the ground seeds with a buffer solution, filtering the seed and buffer solution mixture, and dispensing the seed and buffer solution mixture in the same device reduces the risk of contamination of the seed and buffer solution mixture. Reducing contamination allows for more reliable test results. Further, using a single device to collect seeds, grind the seeds, mix the seeds with a buffer solution, filter a seed and buffer solution mixture, and dispense a seed and buffer solution mixture reduces the space needed to prepare seeds for testing, as no additional equipment is needed. Further, it can be less expensive to have a single device to prepare the seeds for testing.

### Seed Grinder 200

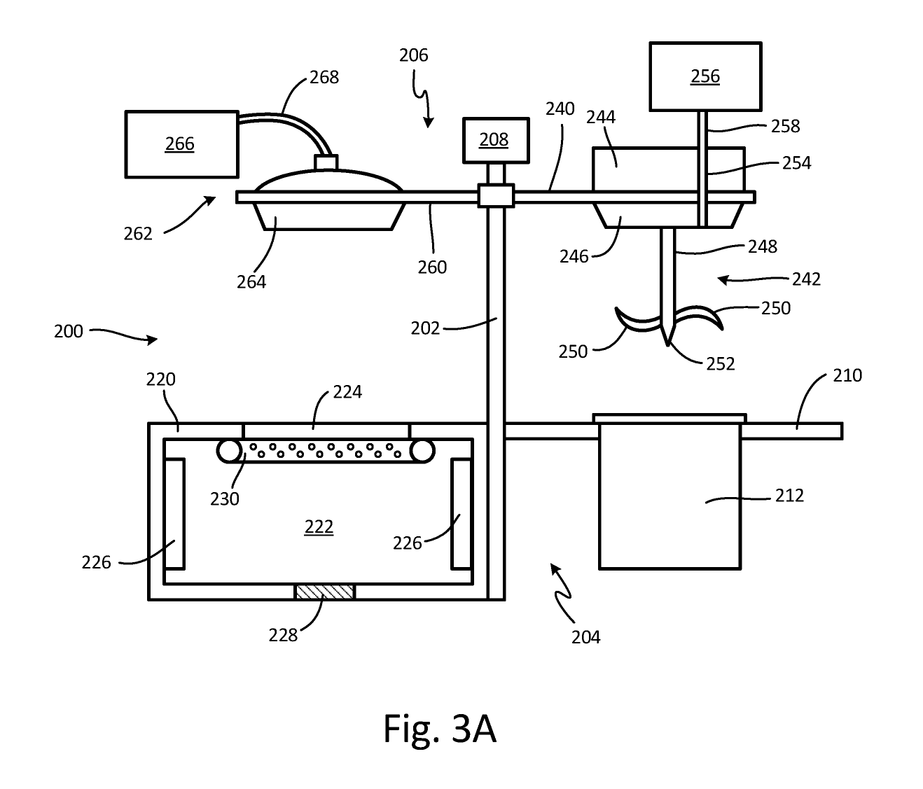

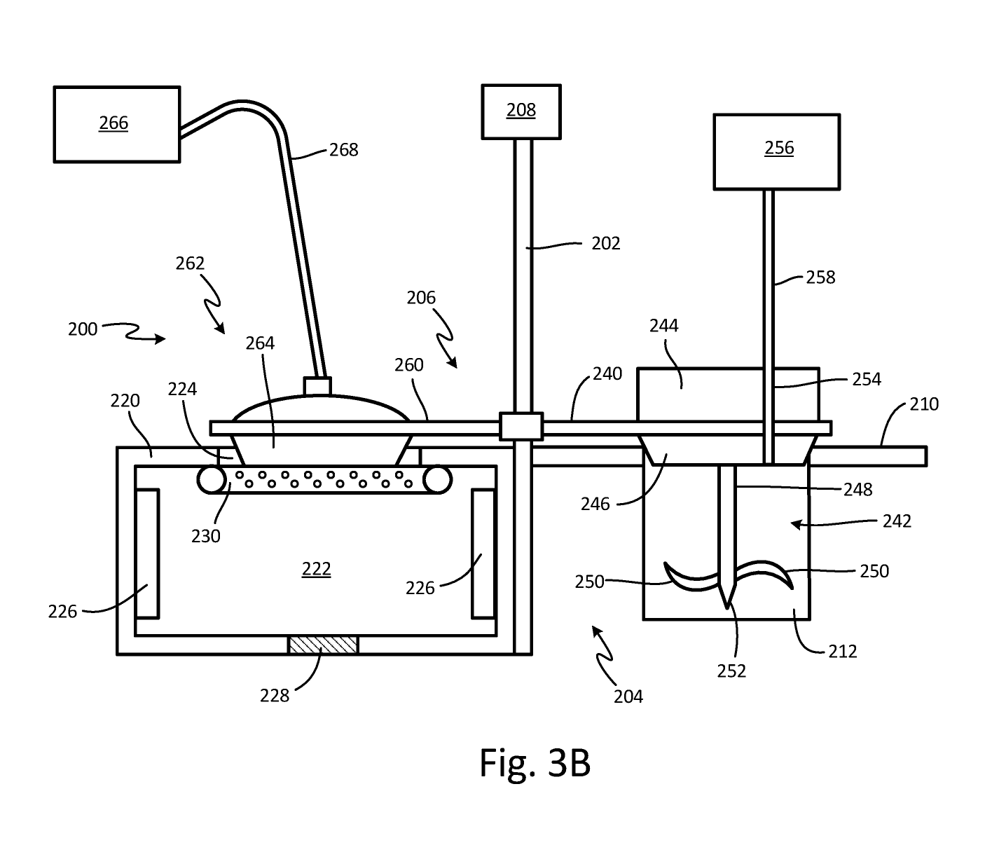

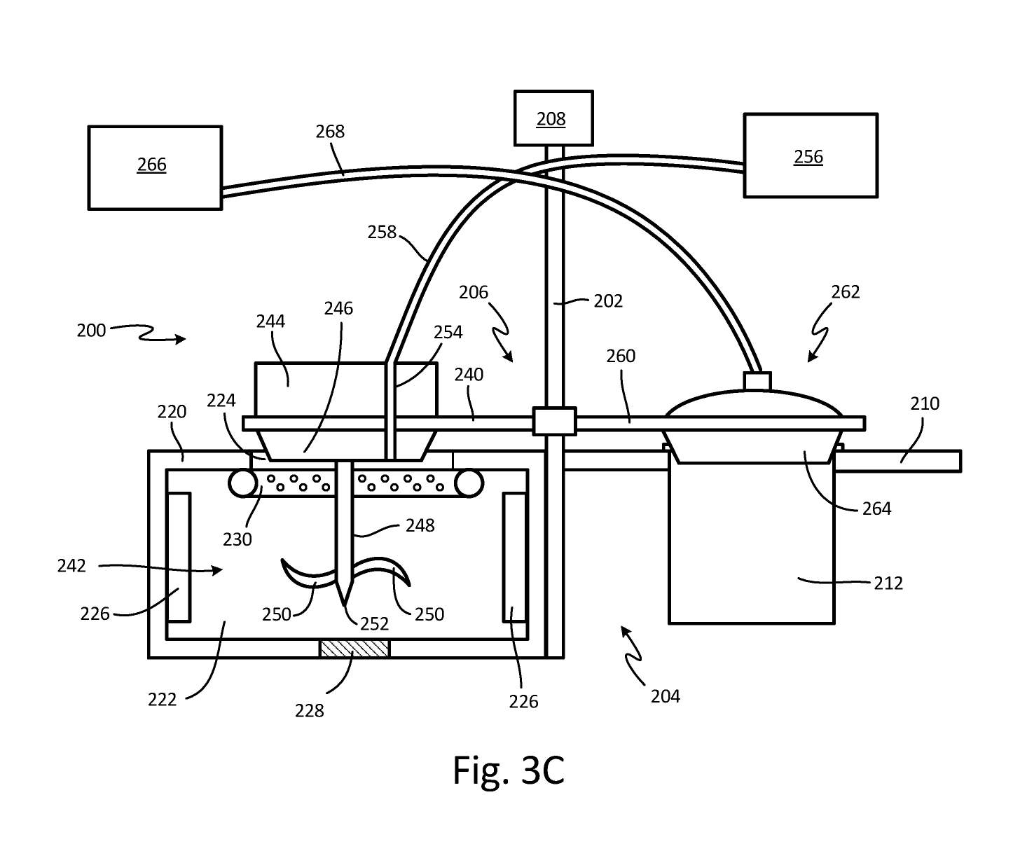

FIG. 3A is a partial cross-sectional side view of seed grinder 200. FIG. 3B is a partial cross-sectional side view of seed grinder 200 when grinding mechanism 242 is positioned to grind seeds. FIG. 3C is a partial cross-sectional side view of seed grinder 200 when dispensing mechanism 262 is positioned to dispense a seed and buffer solution mixture.

Seed grinder 200 includes post 202, stationary portion 204, movable portion 206, and motor 208. Stationary portion 204 includes first arm 210, cup 212, second arm 220, washing station 222, opening 224, water jets 226, drain 228, and air dryer 230. Movable portion 206 includes third arm 240, grinding mechanism 242, motor 244, seal 246, shaft 248, blades 250, drill head 252, buffer port 254, buffer dispenser 256, buffer tube 258, fourth arm 260, dispensing mechanism 262, seal 264, air pressure source 266, and air tube 268.

Seed grinder 200 includes post 202. Stationary portion 204 is attached to a first end of post 202 and is fixed to post 202. As seen in FIG. 3A, movable portion 206 is attached near a second end of post 202. Movable portion 206 is movable up and down along post 202 and can be rotated around post 202. Motor 208 can move movable portion 206 along post 202 and rotate movable portion 206 around post 202. In an alternate embodiment, motor 208 can be replaced by a handle that a user can grasp to manually lift and rotate movable portion 206 along post 202.

Stationary portion 204 includes first arm 210. First arm 210 is a flat plate that extends outward away from post 202 and includes an opening in which cup 212 can be positioned. Cup 212 includes a lip along the upper rim that engages first arm 210 to suspend cup 212 in first arm 210. Cup 212 is capable of containing seeds for grinding.

Stationary portion 204 further includes second arm 220. Second arm 220 is a container that is connected to post 202 along a side wall. Second arm 220 includes washing station 222. Washing station 222 includes opening 224 positioned along a top end of washing station 222 so that an object can be placed in washing station 222 to be washed. Water jets 226 extend along side walls of washing station 202 and direct water towards the object that is placed in washing station 222 for washing. Drain 228 is positioned on a bottom end of washing station 222 and allows water from water jets 226 to drain out of washing station 222. Air dryer 230 is positioned on a bottom side of the top end of washing station 222 adjacent opening 224. Air dryer 230 directs air towards the object that has been washed in washing station 222 to dry the object.

Movable portion 206 includes third arm 240. Third arm 240 is a flat plate that extends outward away from post 202 and includes an opening in which grinding mechanism 242 can be positioned. Grinding mechanism 242 includes motor 244 on a top side of grinding mechanism 242. Motor 244 is connected to a first end of shaft 248 and can rotate shaft 248. Seal 246 is positioned around shaft 248 adjacent to motor 244. Seal 246 can form a sealed connection between grinding mechanism 242 and a cup that grinding mechanism 242 engages. Blades 250 are connected to a second end of shaft 248. In the embodiment shown in FIGS. 3A-3C, there are two blades 250 connected to shaft 248. Blades 250 can include any suitable number of blades in alternate embodiments and blades 250 can be connected to shaft 248 in any suitable manner. When motor 244 rotates shaft 248, blades 250 will rotate with shaft 248. Drill head 252 is also connected to a second end of shaft 248. Buffer port 254 extends through motor 244 and seal 246. Buffer dispenser 256 is connected to buffer port 254 of grinding mechanism 242 with buffer tube 258.

Movable portion 206 also includes fourth arm 260. Fourth arm 260 is a flat plate that extends outwards away from post 202 and includes an opening in which dispensing mechanism 262 can be positioned. Dispensing mechanism 262 includes seal 264 that can form a sealed connected between dispensing mechanism 262 and a cup that is engaged by dispensing mechanism 262. Dispensing mechanism 262 further includes air pressure source 266. Air pressure source 266 is connected to dispensing mechanism 262 with air tube 268.

Seed grinder 200 can be used to grind seeds. Seeds can be placed in cup 212 and cup 212 can be positioned in the opening in first arm 210 of seed grinder 200. Movable portion 206 can then be lowered along post 202 and rotated around post 202 with motor 108 so that grinding mechanism 242 is partially positioned in cup 212, as seen in FIG. 3B. In this position, seal 246 will engage the upper rim of cup 212 to form a seal between grinding mechanism 242 and cup 212. Motor 244 of grinding mechanism 242 can then rotate shaft 248 of grinding mechanism 242. The rotation of shaft 248 will cause blades 250 of grinding mechanism 242 to rotate and grind the seeds that are in cup 212. After the seeds have been ground with grinding mechanism 242 and have achieved a homogenous grind, a buffer solution can be added to cup 212 to form a seed and buffer solution mixture. The buffer solution can be added to cup 212 from buffer dispenser 256 through buffer tube 258 and buffer port 254. In alternate embodiments, buffer can be dispensed into cup 212 through shaft 248 of grinding mechanism 242, grinding mechanism 242 can be removed from cup 212 and buffer can be added directly to cup 212, or buffer tube 258 can extend through dispensing mechanism 262. After the buffer solution is added to cup 212, the seeds and the buffer solution can be ground further with grinding mechanism 242 until a desired consistency is achieved. Movable portion 206 can then be raised with motor 208 to remove grinding mechanism 242 from cup 212.

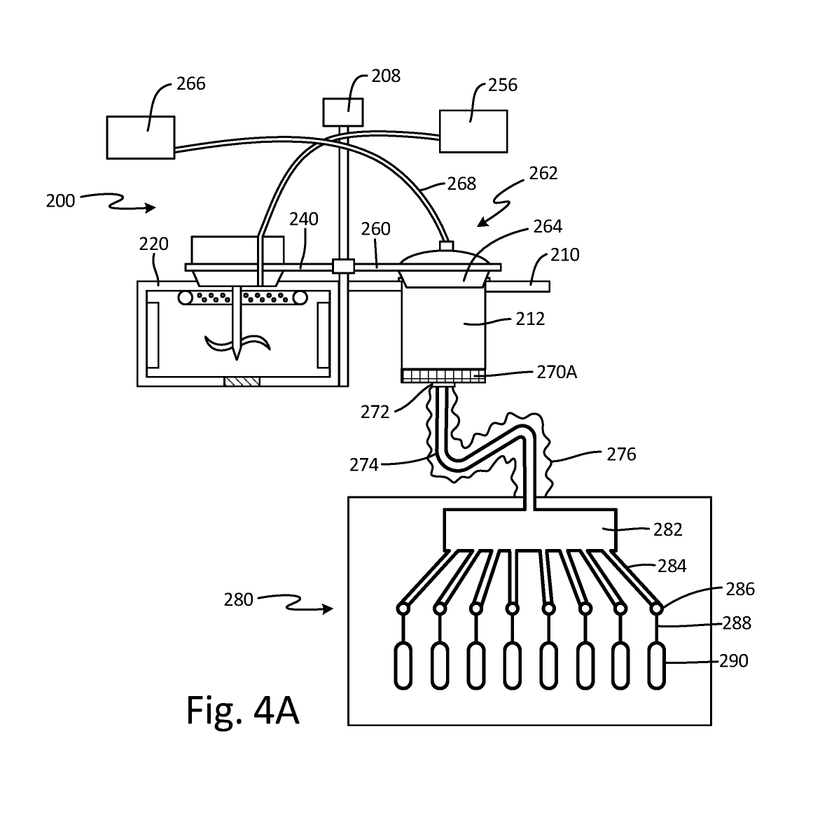

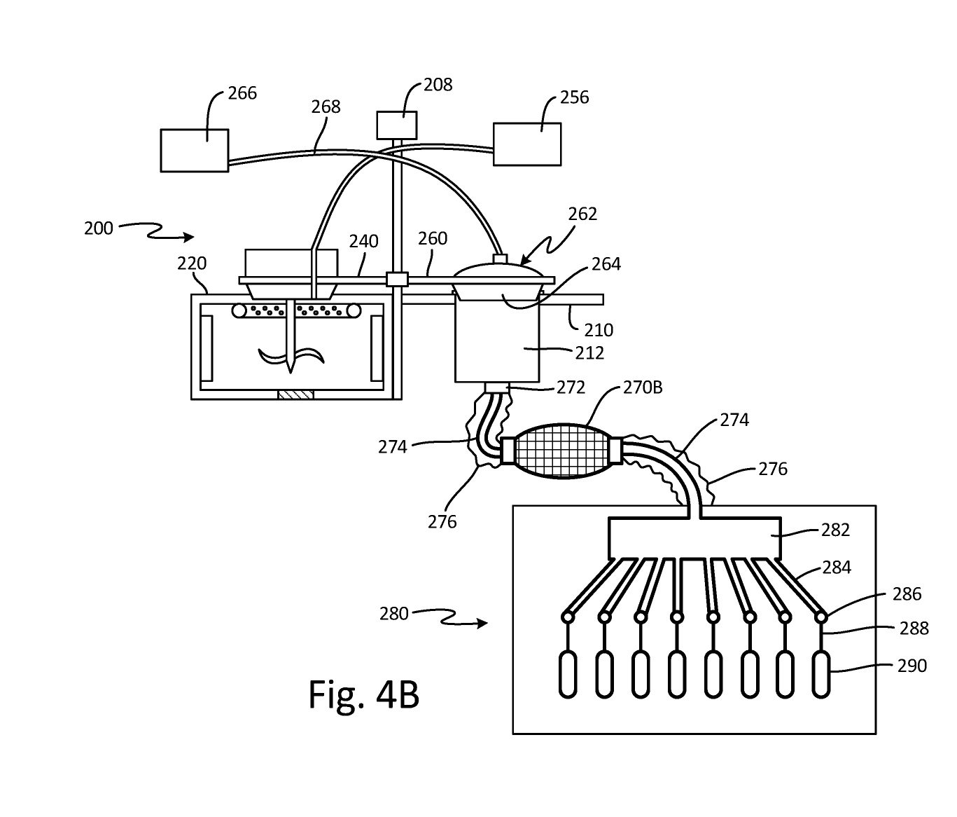

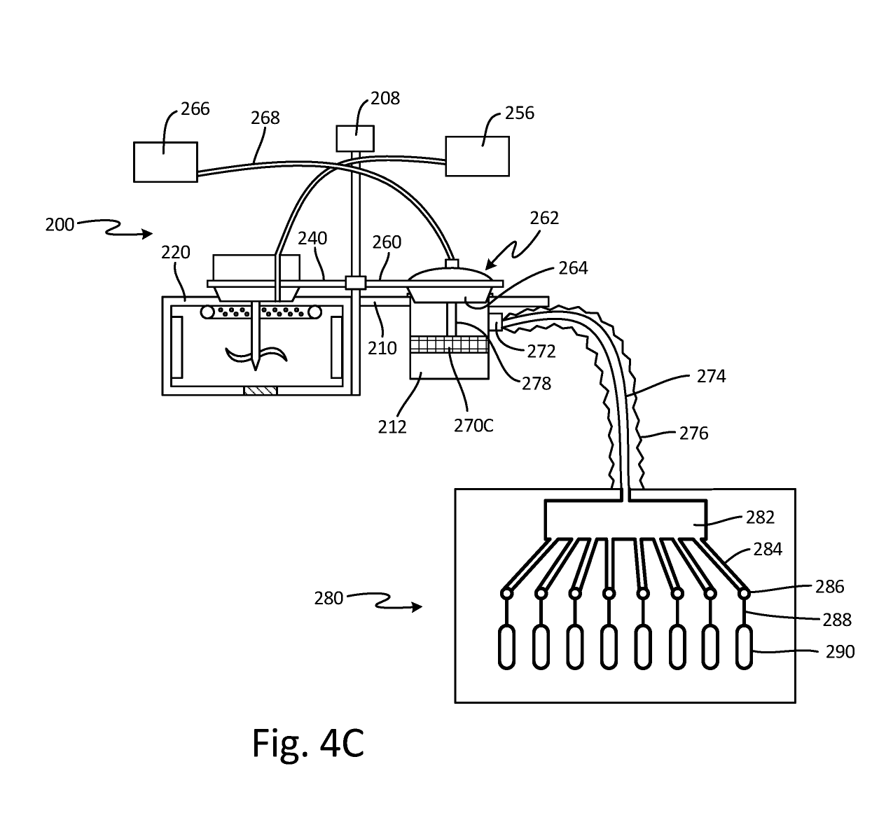

Movable portion 206 can then be rotated around post 202 and lowered along post 202 again so that dispensing mechanism 262 engages cup 212, as seen in FIG. 3C. In this position, seal 264 will engage the upper rim of cup 212 to form a seal between dispensing mechanism 262 and cup 212. Air pressure source 266 can then send air to dispensing mechanism 262 through tube 268 to dispense the seed and buffer solution mixture from cup 212, as will be discussed in more detail in reference to FIGS. 4A-4C. When dispensing mechanism 262 engages cup 212, grinding mechanism 242 will extend through opening 224 and be positioned in washing station 222. Water jets 226 in washing station 222 dispense and direct water towards grinding mechanism 242 to clean grinding mechanism 242. Water that is dispensed in washing station 222 can then drain out of washing station 222 through drain 228, including any seed or buffer solution that has been washed off of grinding mechanism 242. Air dryer 230 can then direct air towards grinding mechanism 242 to dry grinding mechanism 242. After grinding mechanism 242 is cleaned and after dispensing mechanism 262 has dispensed the seed and buffer solution mixture from cup 212, movable portion 206 can be raised along post 202 with motor 208 to remove grinding mechanism 242 from washing station 222 and to remove dispensing mechanism 262 from engagement with cup 212. In an alternate embodiment, grinding mechanism 242 and dispensing mechanism 262 are not attached to movable portion 206, but rather are individual mechanisms that move sequentially.

FIG. 4A is a partial cross-sectional side view of seed grinder 200 dispensing a seed and buffer solution mixture into card consumable 280 using a first configuration. FIG. 4B is a partial cross-sectional side view of seed grinder 100 dispensing a seed and buffer solution mixture into card consumable 280 using a second configuration. FIG. 4C is a partial cross-sectional side view of seed grinder 200 dispensing a seed and buffer solution mixture into card consumable 280 using a third configuration.

FIGS. 4A-4C show seed grinder 200, filter 270, dispensing port 272, dispensing tube 274, heat source 276, and card consumable 280. Seed grinder 200 includes motor 208, first arm 210, cup 212, second arm 220, third arm 240, fourth arm 260, buffer dispenser 256, dispensing mechanism 262, seal 264, air pressure source 266, and air tube 268. Card consumable 280 includes chamber 282, first channels 284, reaction chambers 286, second channels 288, and assay chambers 290.

In the first configuration seen in FIG. 4A, filter 270A is attached to a bottom side of cup 212. After the seeds are ground and mixed with a buffer solution to form a seed and buffer solution mixture, grinding mechanism 242 can be actuated downwards with a motor so that drill head 252 of grinding mechanism 242 perforates and forms a hole in filter 270A that is aligned with dispensing port 272. The a seed and buffer solution mixture can then flow through filter 270A and out of seed grinder 200 through port 272 on the bottom of cup 212. Dispensing tube 274 extends between dispensing port 272 and card consumable 280 and dispenses the seed and buffer solution mixture from seed grinder 200 into card consumable 280. Pressurized air from air pressure source 266 is sent through air tube 268 into cup 212. This air will push the seed and buffer solution mixture through filter 270A and dispensing port 272 into dispensing tube 274. Heat source 276 surrounds dispensing tube 274 to maintain the temperature of the seed and buffer solution mixture in dispensing tube 274.

In the second configuration seen in FIG. 4B, filter 270B is connected to dispensing tube 274. Dispensing port 272 is positioned on a bottom side of cup 212. Dispensing tube 274 extends between dispensing port 272 and card consumable 280. Filter 270B is connected to dispensing tube 274 between dispensing port 272 and card consumable 280. After the seeds are ground and mixed with a buffer solution to form a seed and buffer solution mixture, pressurized air from air pressure source 266 is sent through air tube 268 into cup 212. This air will push the seed and buffer solution mixture through dispensing port 272 into dispensing tube 274. As the seed and buffer solution mixture moves through dispensing tube 274 it will run through filter 270B. Heat source 276 surrounds dispensing tube 274 to maintain the temperature of the seed and buffer solution mixture in dispensing tube 274.

In the third configuration seen in FIG. 4C, filter 270C is connected to dispensing mechanism 262 with shaft 278. When dispensing mechanism is positioned in cup 212, shaft 278 can be extended outwards from dispensing mechanism 262 to push filter 270C through cup 212. This will cause filter 270C to filter the seed and buffer solution mixture and push sediment in the seed and buffer solution mixture into the bottom of cup 212. Dispensing port 272 is positioned on a side of cup 212. Dispensing tube 274 extends between dispensing port 272 and card consumable 280 and dispenses the seed and buffer solution mixture from seed grinder 200 into card consumable 280. After filter 270C is pushed through cup 212 past dispensing port 272, air pressure source 266 can send pressurized air through air tube 268 to push the filtered seed and buffer solution mixture through dispensing port 272 into dispensing tube 274. Heat source 276 surrounds dispensing tube 274 to maintain the temperature of the seed and buffer solution mixture in dispensing tube 274.

In all three configurations seen in FIGS. 4A-4C, the seed and buffer solution mixture will enter into chamber 282 of card consumable 280 from dispensing tube 274. The seed and buffer solution mixture will then flow through first channels 284 into first reaction chambers 286. In first reaction chambers 286, the seed and buffer solution mixture will mix with a reagent mixture to prepare the seed and buffer solution mixture for testing. The seed and reagent mixture will then flow through second channels 288 into assay chambers 290. When the seed and reagent mixture is in assay chambers 290, card consumable 280 can be inserted into a testing device. In the embodiment shown in FIGS. 4A-4C, there are eight first channels 284, first reactions chambers 286, second channels 288, and assay chambers 290. In alternate embodiments, card consumable 280 can include any suitable number of first channels 284, first reactions chambers 286, second channels 288, and assay chambers 290. In further alternate embodiments, card consumable 280 can be a single tube, a tube array, a micro plate, a profile belt, a tape, a pipette tip, a plurality of pipettes, or any other suitable sample holder.

Seed grinder 200 allows a seed to be ground, mixed with a buffer solution, filtered, and dispensed all in a single cup 212. Cup 212 can be a reusable cup that can be washed, or cup 212 can be a consumable cup that is discarded after use. Grinding the seeds, mixing the ground seeds with a buffer solution, filtering the seed and buffer solution mixture, and dispensing the seed and buffer solution mixture in cup 212 reduces the risk of contamination of the seed and buffer solution mixture. Reducing contamination allows for more reliable test results. Further, using a single cup 212 to collect seeds, grind the seeds, mix the seeds with a buffer solution, filter a seed and buffer solution mixture, and dispense a seed and buffer solution mixture reduces the space needed to prepare seeds for testing, as no additional equipment is needed. Further, it can be less expensive to have a single cup 212 to prepare the seeds for testing.

### Seed Grinder 300

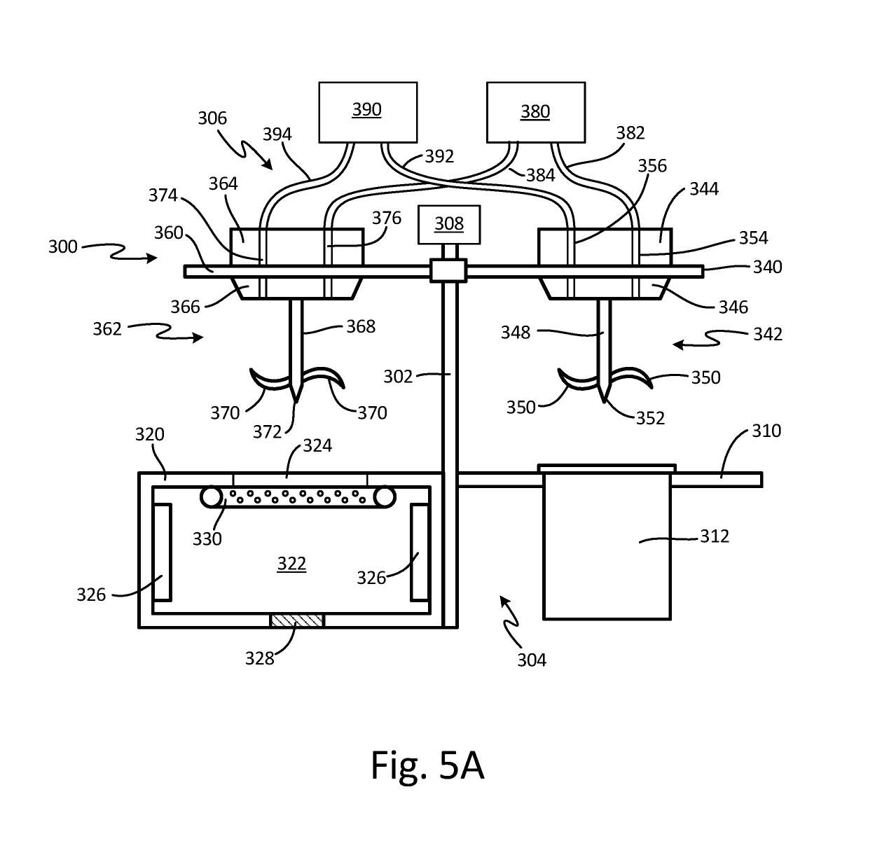

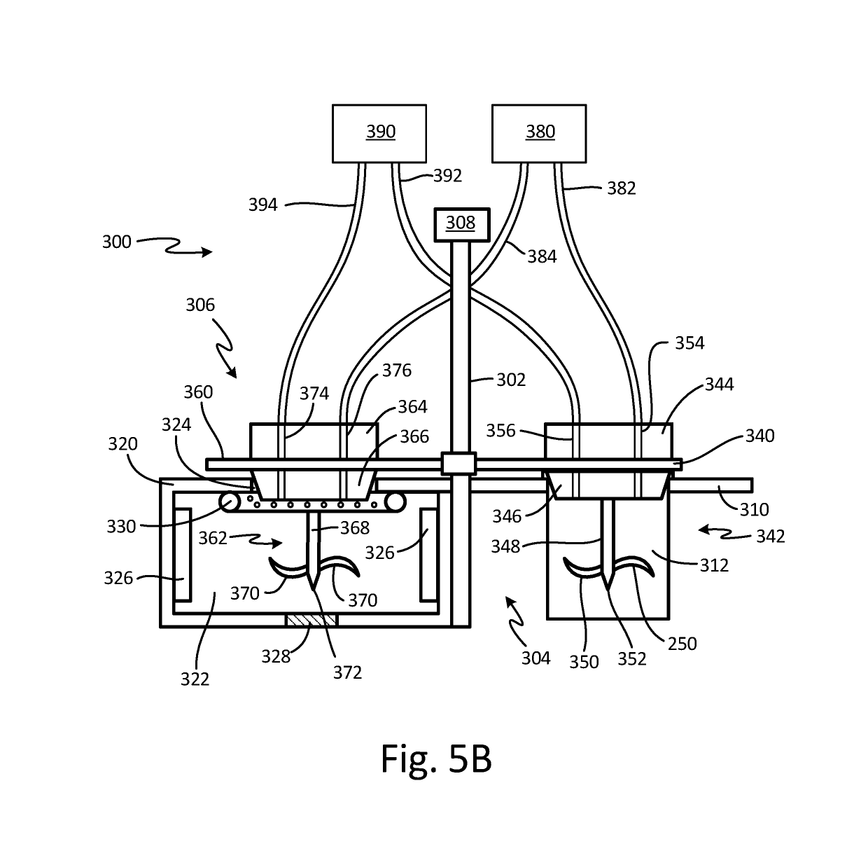

FIG. 5A is a partial cross-sectional side view of seed grinder 300. FIG. 5B is a partial cross-sectional side view of seed grinder 300 when first grinding mechanism 342 is positioned to grind seeds and second grinding mechanism 362 is positioned to be washed.

Seed grinder 300 includes post 302, stationary portion 304, movable portion 306, and motor 308. Stationary portion 304 includes first arm 310, cup 312, second arm 320, washing station 322, opening 324, water jets 326, drain 328, and air dryer 330. Movable portion 306 includes third arm 340, grinding mechanism 342, motor 344, seal 346, shaft 348, blades 350, drill head 352, buffer port 354, air and water port 356, fourth arm 360, grinding mechanism 362, motor 364, seal 366, shaft 368, blades 370, drill head 372, buffer port 374, air and water port 376. FIGS. 5A-5B also show buffer dispenser 380, buffer tube 382, buffer tube 384, air and water source 390, air and water tube 392, and air and water tube 394.

Seed grinder 300 includes post 302. Stationary portion 304 is attached to a first end of post 302 and is fixed to post 302. As seen in FIG. 5A, movable portion 306 is attached near a second end of post 302. Movable portion 306 is movable up and down along post 302 and can be rotated around post 302. Motor 308 can move movable portion 306 along post 302 and rotate movable portion 306 around post 302. In an alternate embodiment, motor 308 can be replaced by a handle that a user can grasp to manually lift and rotate movable portion 306 along post 302.

Stationary portion 304 includes first arm 310. First arm 310 is a flat plate that extends outward away from post 302 and includes an opening in which cup 312 can be positioned. Cup 312 includes a lip along the upper rim that engages first arm 310 to suspend cup 312 in first arm 310. Cup 312 is capable of containing seeds for grinding.

Stationary portion 304 further includes second arm 320. Second arm 320 is a container that is connected to post 302 along a side wall. Second arm 320 includes washing station 322. Washing station 322 includes opening 324 positioned along a top end of washing station 322 so that an object can be placed in washing station 322 to be washed. Water jets 326 extend along side walls of washing station 302 and direct water towards the object that is placed in washing station 322 for washing. Drain 328 is positioned on a bottom end of washing station 322 and allows water from water jets 326 to drain out of washing station 322. Air dryer 330 is positioned on a bottom side of the top end of washing station 322 adjacent opening 324. Air dryer 330 directs air towards the object that has been washed in washing station 322 to dry the object.

Movable portion 306 includes third arm 340. Third arm 340 is a flat plate that extends outward away from post 302 and includes an opening in which grinding mechanism 342 can be positioned. Grinding mechanism 342 includes motor 344 on a top side of grinding mechanism 342. Motor 344 is connected to a first end of shaft 348 and can rotate shaft 348. Seal 346 is positioned around shaft 348 adjacent to motor 344. Seal 346 can form a sealed connected between grinding mechanism 342 and another object. Blades 350 are connected to a second end of shaft 348. In the embodiment shown in FIGS. 5A-5B, there are two blades 350 connected to shaft 348. Blades 350 can include any suitable number of blades in alternate embodiments and blades 350 can be connected to shaft 348 in any suitable manner. When motor 344 rotates shaft 348, blades 350 will rotate with shaft 348. Drill head 352 is also connected to a second end of shaft 348. Buffer port 354 and air and water port 356 extend through motor 344 and seal 346.

Movable portion 306 also includes fourth arm 360. Fourth arm 360 is a flat plate that extends outward away from post 302 and includes an opening in which grinding mechanism 362 can be positioned. Grinding mechanism 362 includes motor 364 on a top side of grinding mechanism 362. Motor 364 is connected to a first end of shaft 368 and can rotate shaft 368. Seal 366 is positioned around shaft 368 adjacent to motor 364. Seal 366 can form a sealed connected between grinding mechanism 362 and another object. Blades 370 are connected to a second end of shaft 368. In the embodiment shown in FIGS. 5A-5B, there are two blades 370 connected to shaft 368. Blades 370 can include any suitable number of blades in alternate embodiments and blades 370 can be connected to shaft 368 in any suitable manner. When motor 364 rotates shaft 368, blades 370 will rotate with shaft 368. Drill head 372 is also connected to a second end of shaft 368. Buffer port 374 and air and water port 376 extend through motor 364 and seal 366.

Also shown in FIGS. 5A-5B is buffer dispenser 380 and air and water source 390. Buffer dispenser 380 and air and water source 390 can be a part of seed grinder 300 or can be provided separately from seed grinder 300. Buffer dispenser 380 is connected to buffer port 354 of first grinding mechanism 342 with buffer tube 382 and is connected to buffer port 374 of second grinding mechanism 362 with buffer tube 384. Air and water source 390 is connected to air and water port 356 of first grinding mechanism 342 with air and water tube 392 and is connected to air and water port 376 of second grinding mechanism 362 with air and water tube 394.

Seed grinder 300 can be used to grind seeds. Seeds can be placed in cup 312 and cup 312 can be positioned in the opening in first arm 310 of seed grinder 300. Movable portion 306 can then be lowered along post 302 and rotated around post 302 with motor 308 so that grinding mechanism 342 is positioned in cup 312, as seen in FIG. 5B. In this position, seal 346 of first grinding mechanism 342 will engage the upper rim of cup 312 to form a seal between grinding mechanism 342 and cup 312. Motor 344 of first grinding mechanism 342 can then rotate shaft 348 of first grinding mechanism 342. The rotation of shaft 348 will cause blades 350 of grinding mechanism 342 to rotate and grind the seeds that are in cup 312. After the seeds have been ground with grinding mechanism 342 and have achieved a homogenous grind, a buffer solution can be added to cup 312 to form a seed and buffer solution mixture. The buffer solution can be added to cup 312 from buffer dispenser 380 through buffer tube 382 and buffer port 354. In alternate embodiments, buffer can be dispensed into cup 312 through shaft 348 of first grinding mechanism 342 or first grinding mechanism 342 can be removed from cup 312 and buffer can be added directly to cup 312. After the buffer solution is added to cup 312, the seeds and the buffer solution can be ground further with first grinding mechanism 342 until a desired consistency is achieved.

The seed and buffer solution mixture can be dispensed from cup 312 using seed grinder 300. Shaft 348 of first grinding mechanism 342 can be actuated downwards so that drill head 352 at the second end of shaft 348 punctures a bottom of cup 312. Air can then be delivered to cup 312 from air and water source 390 through air and water tube 392 and air and water port 356. The air will pressurize cup 312 and force the seed and buffer solution mixture through the punctured hole in the bottom of cup 312. The seed and buffer solution mixture can then be dispensed into a sample holder from cup 312. The sample holder can be a card consumable, a single tube, a tube array, a micro plate, a profile belt, a tape, a pipette tip, a plurality of pipettes, or any other suitable sample holder.

When first grinding mechanism 342 is positioned in cup 312, second grinding mechanism 362 is positioned in washing station 322. Water jets 326 in washing station 322 dispense and direct water towards second grinding mechanism 362 to clean second grinding mechanism 362. Water from air and water source 390 can also flow through air and water tube 394 and air and water port 376 to clean second grinding mechanism 362. Water that is dispensed in washing station 322 to wash second grinding mechanism 362 can then drain out of washing station 322 through drain 328, including any seed or buffer solution that has been washed off of second grinding mechanism 362. Air dryer 330 can then direct air towards second grinding mechanism 362 to dry second grinding mechanism 362. Air from air and water source 390 can also flow through air and water tube 394 and air and water port 376 to dry second grinding mechanism 362.

Movable portion 306 can be raised with motor 308 to remove first grinding mechanism 342 from cup 312 and second grinding mechanism 362 from washing station 322. Movable portion 306 can then be rotated around post 302 and lowered along post 302 again so that first grinding mechanism 342 is positioned in washing station 322 and second grinding mechanism 362 is positioned in cup 312. This allows both first grinding mechanism 342 and second grinding mechanism 362 to be grind seeds in cup 312 and be cleaned in washing station 322. When first grinding mechanism 342 is grinding seeds in cup 312, second grinding mechanism 362 can be washed in washing station 322, and when first grinding mechanism 342 is being washing in washing station 322, second grinding mechanism 362 can grind seeds in cup 312. In an alternate embodiment, first grinding mechanism 342 and second grinding mechanism 362 are not attached to movable portion 306, but rather are individual mechanisms that move sequentially.

Seed grinder 300 allows a seed to be ground, mixed with a buffer solution, filtered, and dispensed all in a single cup 312. Cup 312 can be a reusable cup that can be washed, or cup 312 can be a consumable cup that is discarded after use. Grinding the seeds, mixing the ground seeds with a buffer solution, filtering the seed and buffer solution mixture, and dispensing the seed and buffer solution mixture in cup 312 reduces the risk of contamination of the seed and buffer solution mixture. Reducing contamination allows for more reliable test results. Further, using a single cup 312 to collect seeds, grind the seeds, mix the seeds with a buffer solution, filter a seed and buffer solution mixture, and dispense a seed and buffer solution mixture reduces the space needed to prepare seeds for testing, as no additional equipment is needed. Further, it can be less expensive to have a single cup 312 to prepare the seeds for testing.

### Cup Consumable 400

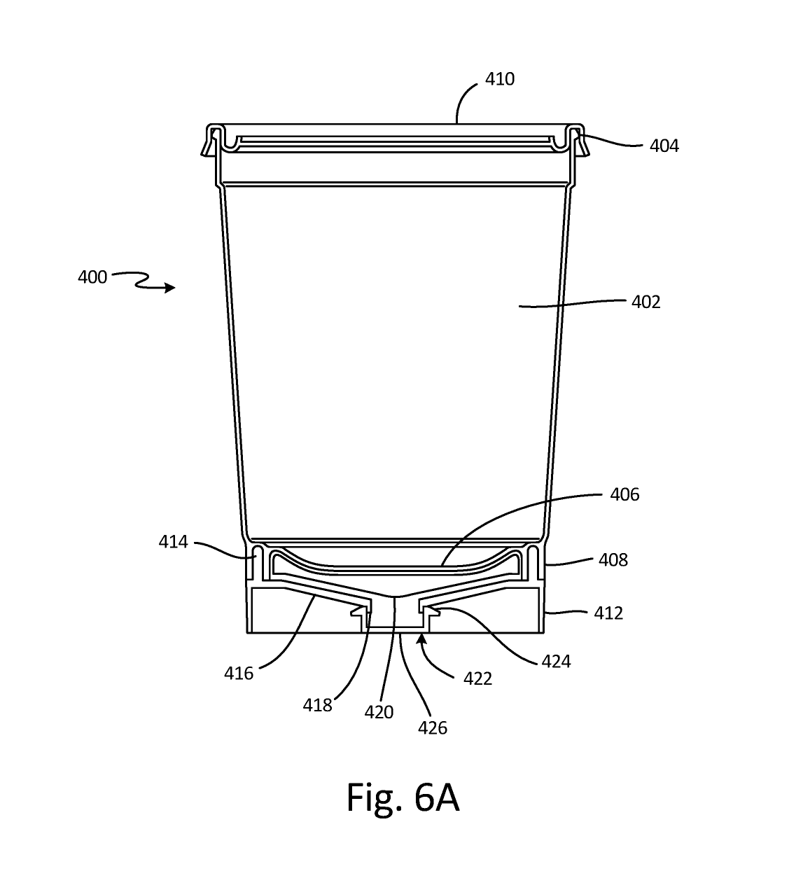

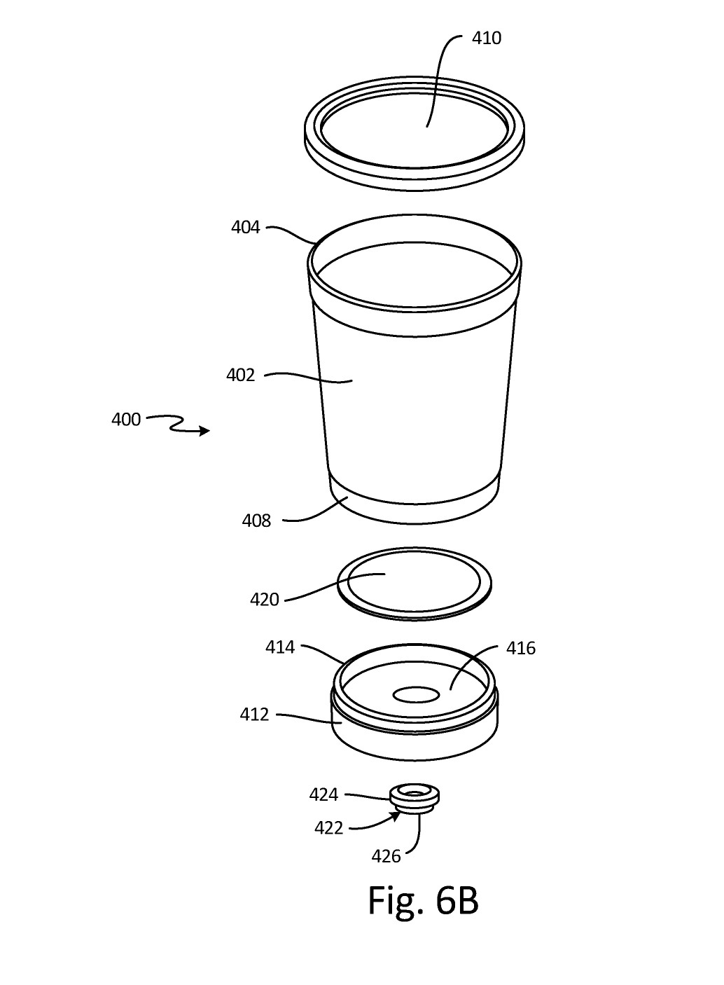

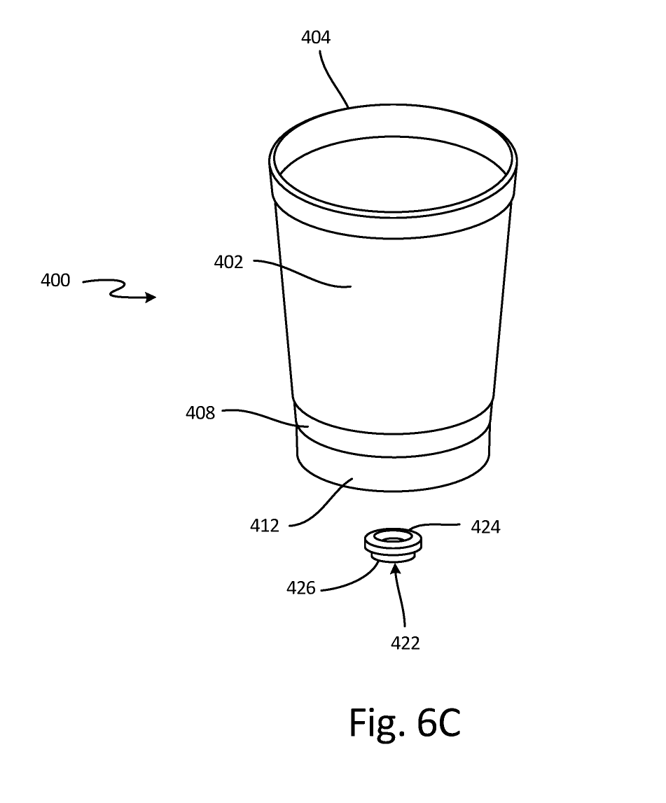

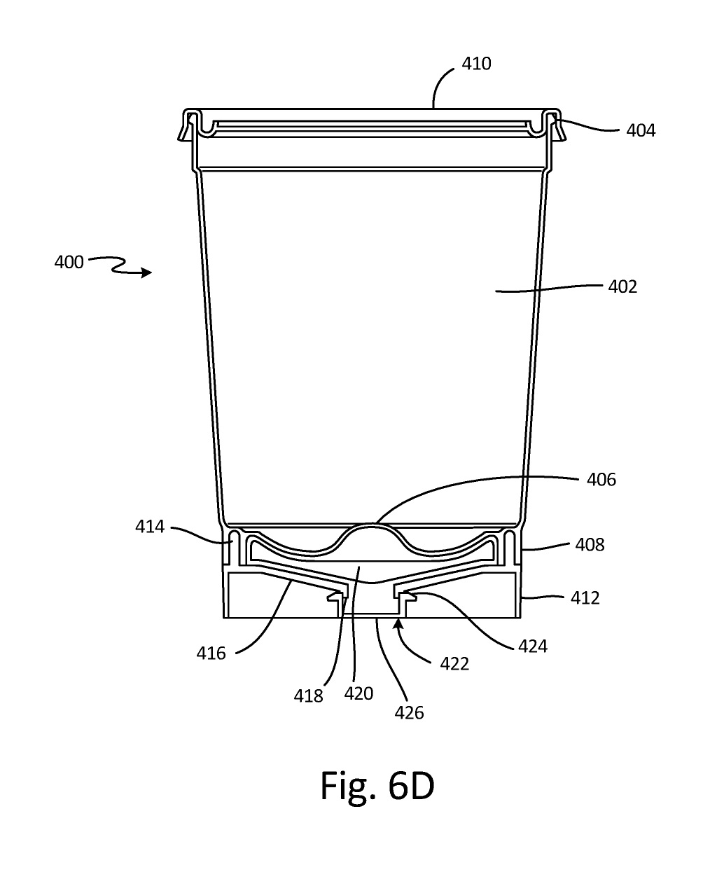

FIG. 6A is a side cross-sectional view of cup consumable 400. FIG. 6B is an exploded view of cup consumable 400. FIG. 6C is isometric view of cup consumable 400 when aspirate cup 420 has been removed from cup consumable 400. FIG. 6D is a side cross-sectional view of an alternate configuration of cup consumable 400.

Cup consumable 400 includes cup 402, upper rim 404, bottom portion 406, bottom rim 408, lid 410, filter housing 412, upper rim 414, sloped bottom portion 416, bottom rim 418, filter 420, aspirate cup 422, upper rim 424, and bottom portion 426.

Cup consumable 400 can be used to prepare seeds for testing. After seeds are prepared for testing and dispensed from cup consumable 400, cup consumable 400 can be discarded. Cup consumable 400 includes cup 402 that forms a body portion of cup consumable 400. Cup 402 has upper rim 404 at an upper end of cup 402 that surrounds an opening to cup 402. Cup 402 has bottom portion 406 at a lower end of cup 402. In FIGS. 6A-6C, bottom portion 406 is a flat bottom piece of cup 402. In FIG. 6D, bottom portion 406 has a raised middle portion to encourage seeds in cup 402 to an outer edge of cup 402 to be ground by blades on a grinding mechanism that can be positioned in cup 402. Extending downward from bottom portion 406 is bottom rim 408 of cup 402. Cup consumable 400 further includes lid 410. Lid 410 forms a snap fit with upper rim 404 of cup 402 in the embodiment shown in FIGS. 6A-6D, but can attached to cup 402 in any manner in alternate embodiments. Lid 410 is capable of sealing contents in cup 402 of cup consumable 400.

Filter housing 412 includes upper rim 414 that forms a snap fit with bottom rim 408 of cup 402 in the embodiment shown in FIGS. 6A-6D. Filter housing 412 can be attached to cup 402 in any suitable manner in alternate embodiments. Filter housing 412 further includes sloped bottom portion 416 extending from upper rim 414 to an opening at the center of filter housing 412. Extending downward from sloped bottom portion 416 is bottom rim 418 of filter housing 412. Bottom rim 418 surrounds the opening in filter housing 412. Filter 420 can be positioned in filter housing 412 between bottom portion 406 of cup 402 and sloped bottom portion 416 of filter housing 412. Filter 420 is compressed between cup 402 and filter housing 412.

Aspirate cup 422 includes upper rim 424 that forms a snap fit with bottom rim 416 of filter housing 412. Aspirate cup 422 further includes bottom portion 426 that is a flat bottom piece of aspirate cup 422. Aspirate cup 422 is aligned with the opening in filter housing 412. The opening in filter housing 412 and aspirate cup 422 can be any size in alternate embodiments.

Cup consumable 400 is capable of storing seeds that have been collected in cup consumable 400. Seeds that are collected can be placed in cup consumable 400. Cup 402 of cup consumable 400 can have a fill line indicating how many seeds should be placed in cup 402. When cup 402 is filled, lid 410 can be placed on upper rim 404 of cup 402 to seal the seeds in cup consumable 400. Cup consumable 400 can then be transported or stored until the seeds are to be tested. When the seeds are to be tested, lid 410 can be removed from cup 402. Cup consumable 400 can then be positioned in a seed grinder, such as seed grinder 200 shown in FIGS. 3A-4C or seed grinder 300 shown in FIGS. 5A-5B. A seed grinding mechanism can then be inserted into cup 402 to grind the seeds in cup 402 of cup consumable 400. After the seeds are ground, a buffer solution can be added to cup 402 of cup consumable 400 and mixed with the ground seeds to form a seed and buffer solution mixture. The seed grinding mechanism or a puncture mechanism can then be used to puncture a hole in bottom portion 406 of cup 402. The seed and buffer solution mixture can then flow from cup 402 into filter housing 412. As the seed and buffer solution mixture flows into filter housing 412, it will pass through filter 420. Filter 420 is compressed between cup 402 and filter housing 412 to ensure that the seed and buffer solution mixture flows through filter 420 as it passes from cup 402 to filter housing 412.

Filter 420 is made from a polypropylene felt material in the embodiment shown. Filter 420 is used to filter the seed and buffer solution mixture as it flows from cup 402 into filter housing 412. Polypropylene felt has absorption tendencies that help wick fluid and filter more rapidly than other filter materials. Polypropylene felt also has oil removing properties for a cleaner and better filtered mixture for DNA extraction, which leads to less background noise during testing. Other synthetic polymer materials can also be used as nonwoven felt filter media, including but are not limited to polyester, polytetrafluorethylene (commonly referred to as Teflon®), aramid, poly-paraphenylene terephthalamide (commonly referred to as Kevlar®), nylon, or rayon. Woven felt, pressed felt, and needled felt are all examples of types of materials that can also be used for filtration.

The seed and buffer solution mixture that has been filtered through filter 420 can then flow through the opening of filter housing 412 into aspirate cup 422. Sloped bottom 412 of filter housing 412 helps direct the seed and buffer solution mixture through the opening of filter housing 412 and into aspirate cup 422. Aspirate cup can be separated from cup consumable 400, as seen in FIG. 6C. When the seed and buffer solution mixture has flowed through cup 402 and filter housing 412 into aspirate cup 422, aspirate cup 422 can be removed from cup consumable 400 and the seed and buffer solution mixture in aspirate cup 422 can be aspirated and transferred to a sample holder for testing. In an alternate embodiment, aspirate cup 400 does not include aspirate cup 422, but rather the seed and buffer solution mixture is passed through filter housing 412 directly into a sample holder for testing. Cup 402 and/or aspirate cup 422 of cup consumable 400 can have a barcode on a bottom to track cup 402 and/or aspirate cup 422.

Cup consumable 400 allows a seed to be ground, mixed with a buffer solution, filtered, and dispensed all in one consumable that can then be discarded. Cup consumable 400 is further capable of storing and transporting seeds prior to grinding the seeds for testing. Cup consumable 400 can be used with a seed grinder that includes a grinding mechanism that can be positioned in cup 402 of cup consumable 400.

### Cup Consumable 500

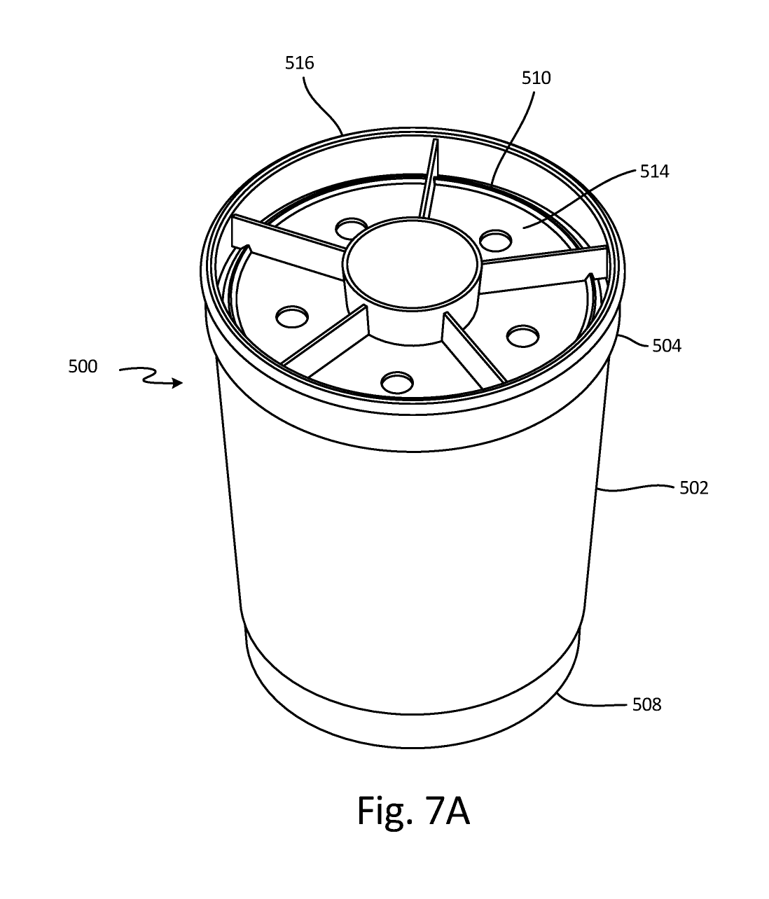

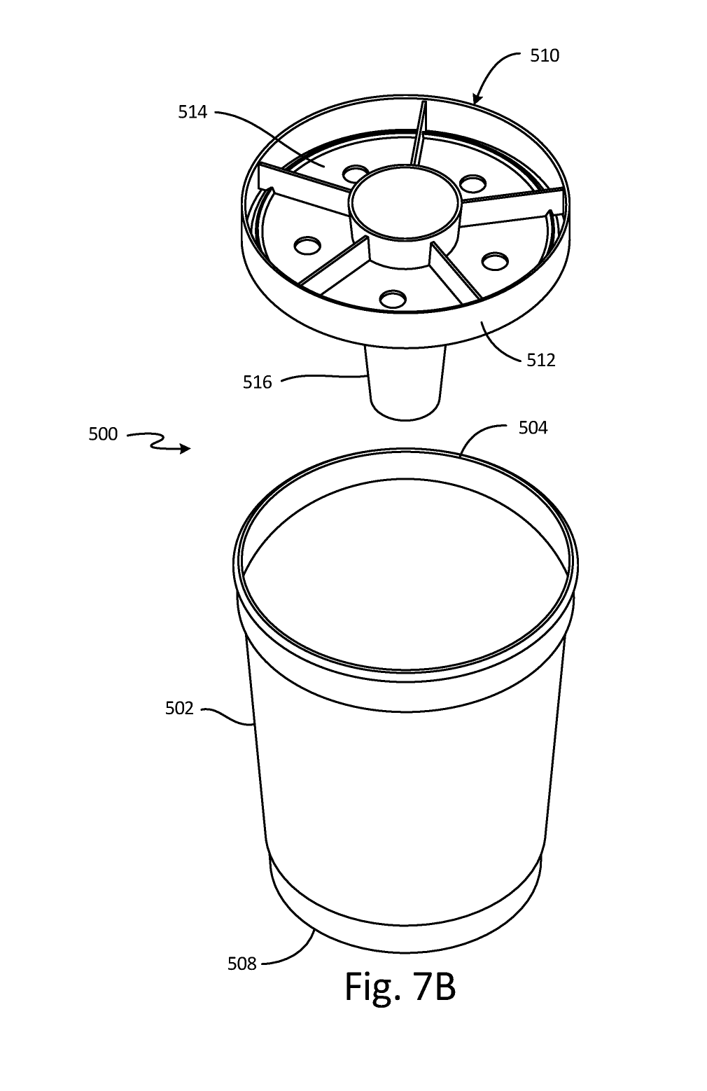

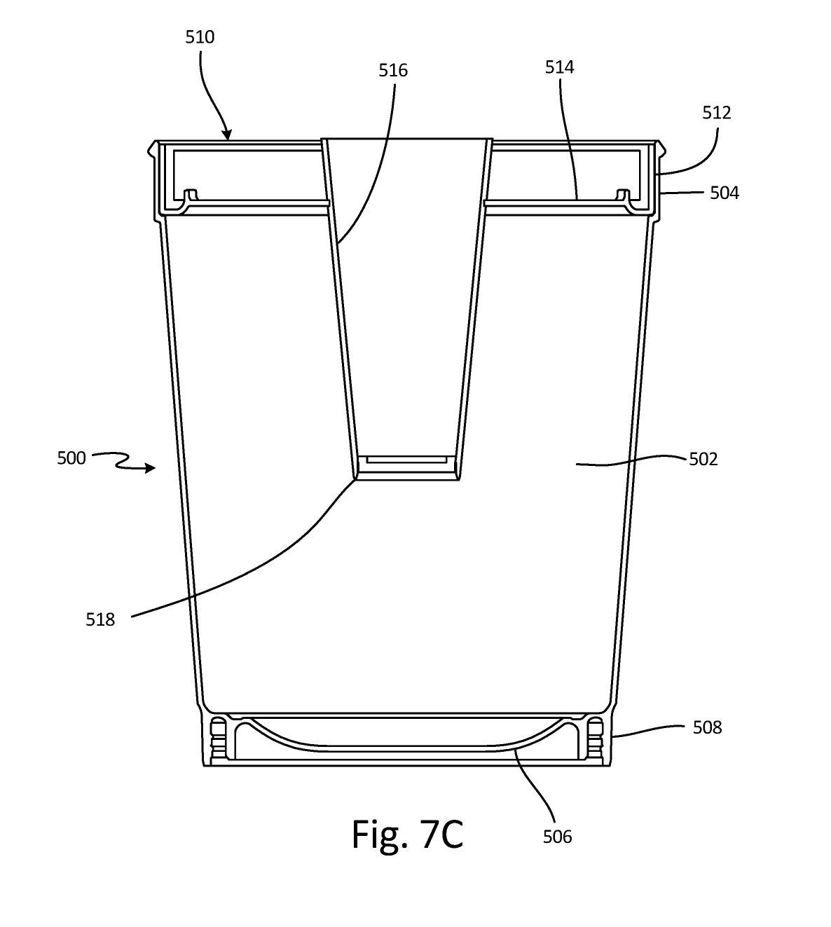

FIG. 7A is an isometric view of cup consumable 500. FIG. 7B is an exploded view of cup consumable 500. FIG. 7C is a side cross-sectional view of cup consumable 500.

Cup consumable 500 includes cup 502, upper rim 504, bottom portion 506, bottom rim 508, lid 510, outer rim 512, body portion 514, center cylinder 518, and lip 518.

Cup consumable 500 can be used to prepare seeds for testing. After seeds are prepared for testing and dispensed from cup consumable 500, cup consumable 500 can be discarded. Cup consumable 500 includes cup 502 that forms a body portion of cup consumable 500. Cup 502 has upper rim 504 at an upper end of cup 502 that surrounds an opening to cup 502. Cup 502 has bottom portion 506 that is a flat bottom piece of cup 502. Extending downward from bottom portion 506 is bottom rim 508 of cup 502.

Cup consumable 500 further includes lid 510. Lid 510 includes outer rim 512 that forms an interference fit with upper rim 504 of cup 502. Extending inward from outer rim 512 of lid 510 is body portion 514. Body portion 514 extends inwards to center cylinder 518. Center cylinder 518 has an opening at a top end and a bottom end. Lip 518 is positioned adjacent to a bottom end of center cylinder 516. A filter can be positioned in center cylinder 516 and held in place on lip 518. Cup 502 of cup consumable 500 can have a barcode on a bottom to track cup 502.

Seeds can be placed in cup 502 of cup consumable 500. Cup consumable 500 can then be positioned in a seed grinder, such as seed grinder 200 shown in FIGS. 3A-4C or seed grinder 300 shown in FIGS. 5A-5B. A grinding mechanism can be positioned in cup 502 to grind the seeds prior to placing lid 510 on cup 502. After the seeds are ground, a buffer solution can be added to cup 502 and mixed with the ground seeds to form a seed and buffer solution mixture. Lid 510 can then be positioned on cup 502. Center cylinder 516 can be immersed in the seed and buffer solution and the seed and buffer solution mixture can be sucked up through center cylinder 516 of lid 510. In an alternate embodiment, cup consumable 500 can be pressurized to force the seed and buffer solution mixture up through center cylinder 516 of lid 510 or a vacuum can be applied to suck the seed and buffer solution mixture up through center cylinder 516 of lid 510.

As the seed and buffer solution mixture is pushed up through center cylinder 516 of lid 510, it can pass through a filter that is positioned in center cylinder 516 of lid 510. The seed and buffer solution mixture that has been pushed up through center cylinder 516 of lid 510 can then be aspirated out of center cylinder 516 and transferred to a sample holder for testing.

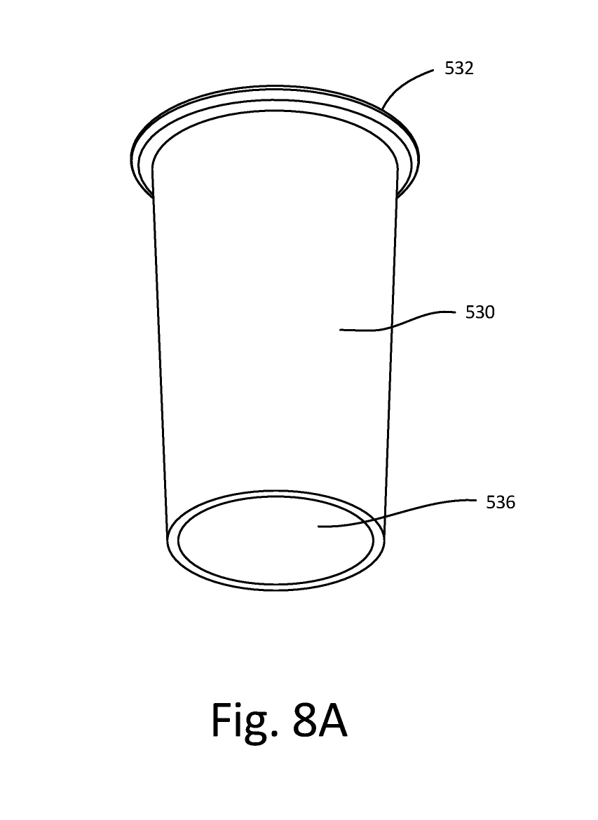

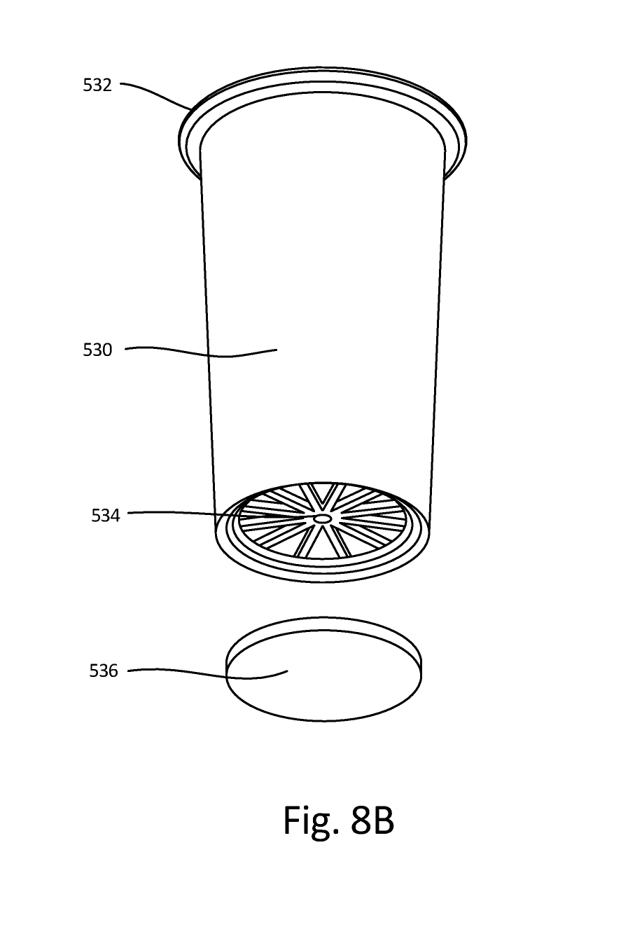

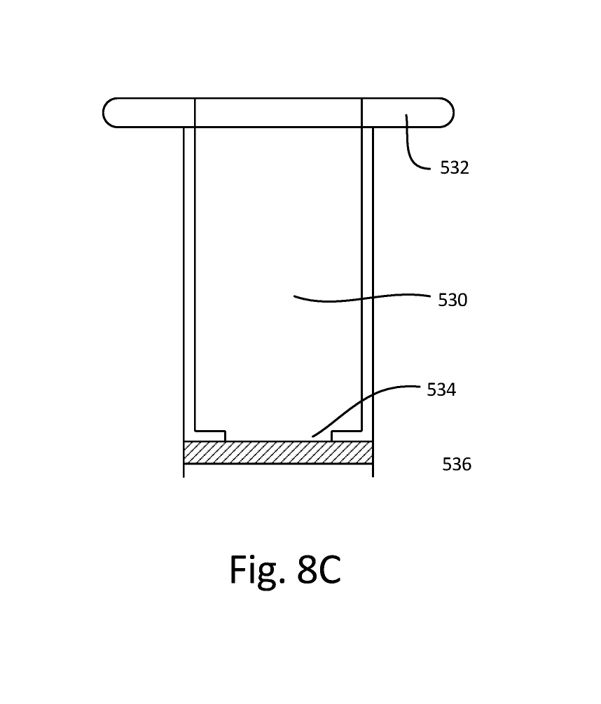

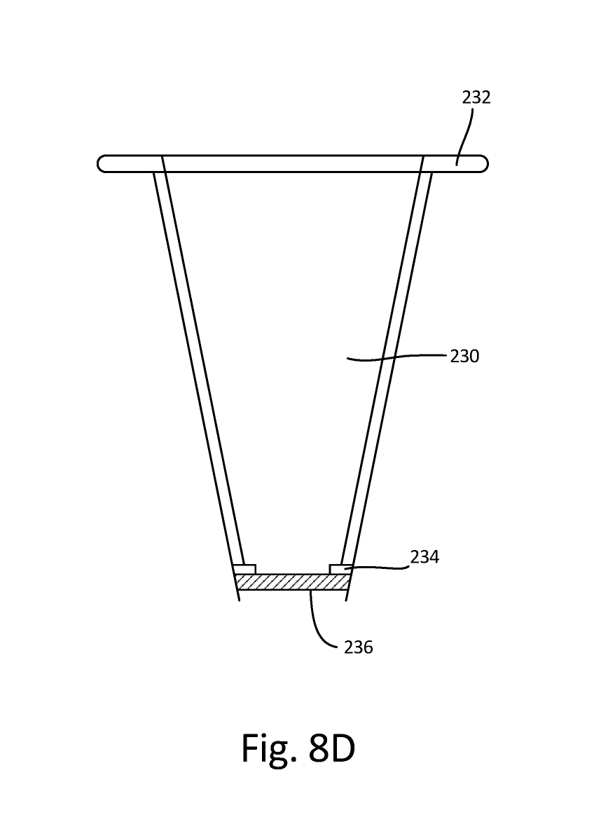

FIG. 8A is an isometric view of filter tube 530. FIG. 8B is an exploded view of filter tube 530. FIG. 8C is a cross-sectional view of filter tube 530. FIG. 8D is a cross-sectional view of an alternate configuration of filter tube 530.

Filter tube 530 includes upper lip 532, bottom portion 534, and filter 536.

Filter tube 530 is a cylindrical tube. Upper lip 532 is positioned at a top end of filter tube 530. Bottom portion 534 is at a bottom end of filter tube 530 and is perforated. In FIGS. 8A-8C, filter tube 530 has walls that are perpendicular to bottom portion 534. In FIG. 8D, filter tube 530 has sloped walls that slope towards bottom portion 534. Filter 536 is positioned on a bottom side of bottom portion 534 and is held in place in filter tube 530.

Filter 536 is made from a polypropylene felt material in the embodiment shown. Filter 536 is used to filter the seed and buffer solution mixture as it flows from a cup into filter tube 530. Polypropylene felt has absorption tendencies that help wick fluid and filter more rapidly than other filter materials. Polypropylene felt also has oil removing properties for a cleaner and better filtered mixture for DNA extraction, which leads to less background noise during testing. Other synthetic polymer materials can also be used as nonwoven felt filter media, including but are not limited to polyester, polytetrafluorethylene (commonly referred to as Teflon®), aramid, poly-paraphenylene terephthalamide (commonly referred to as Kevlar®), nylon, or rayon. Woven felt, pressed felt, and needled felt are all examples of types of materials that can also be used for filtration.

Filter tube 530 can be positioned in center cylinder 516 of lid 510 of cup consumable 500 shown in FIGS. 7A-7C. Cup consumable 500 can be pressurized when filter tube 530 is positioned in center cylinder 516 of lid 510 to force the seed and buffer solution mixture up through filter 536 of filter tube 530. The seed and buffer solution mixture that is filtered through filter 536 and is held in filter tube 530 can be aspirated out of filter tube 530 and transferred to a sample holder for testing.

### Cup Consumable 600

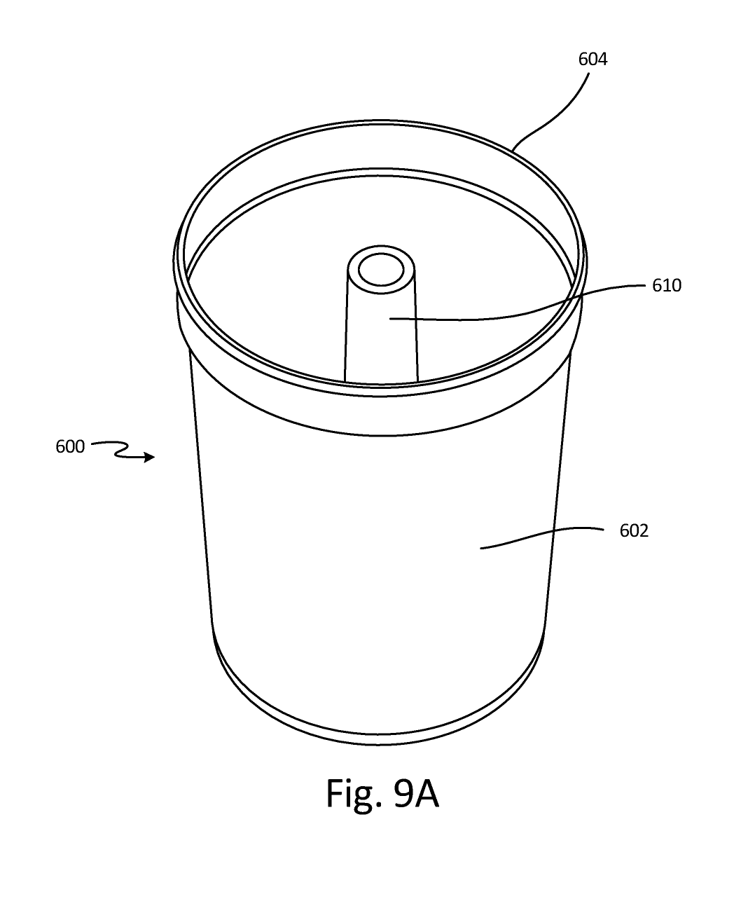

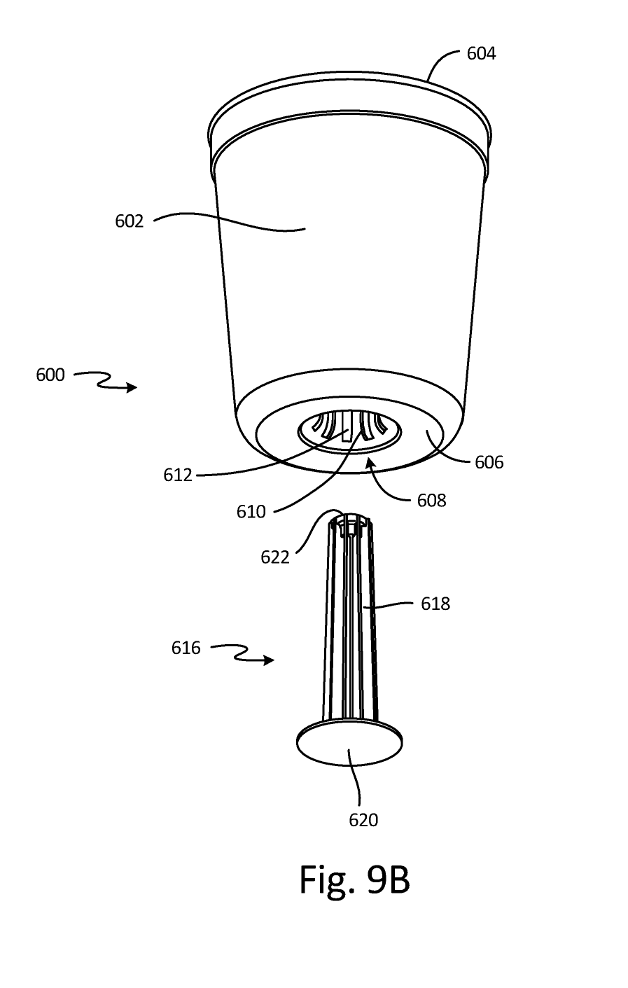

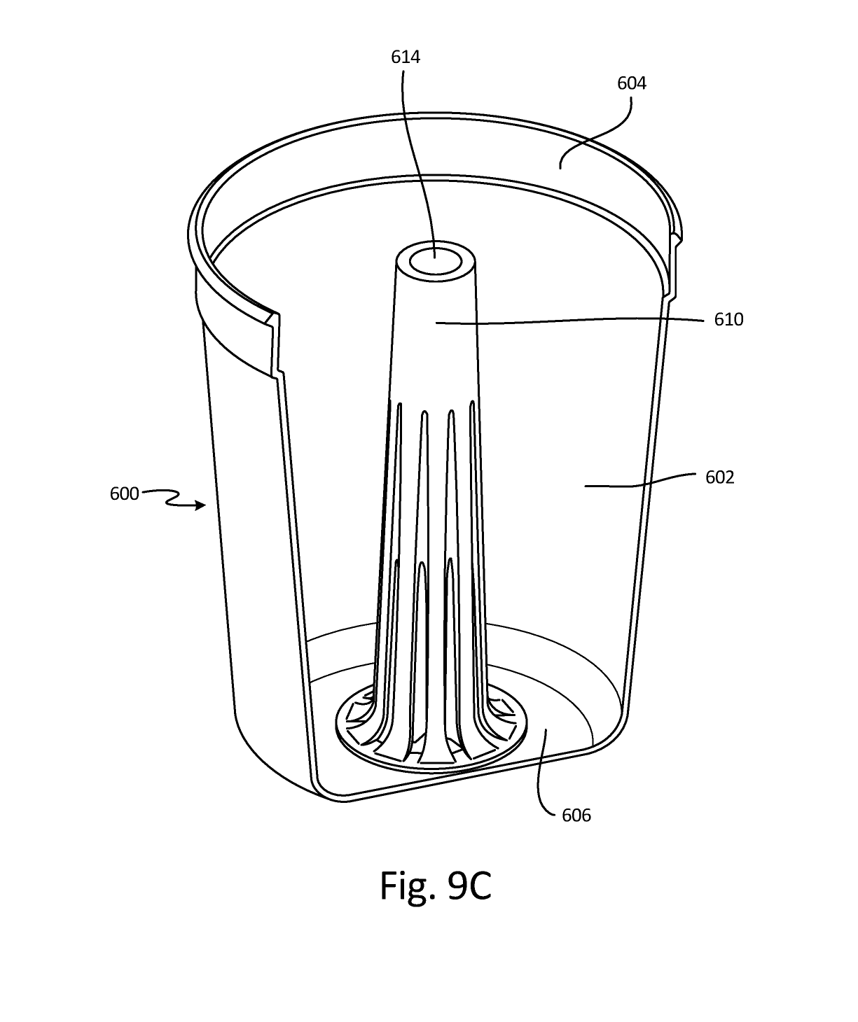

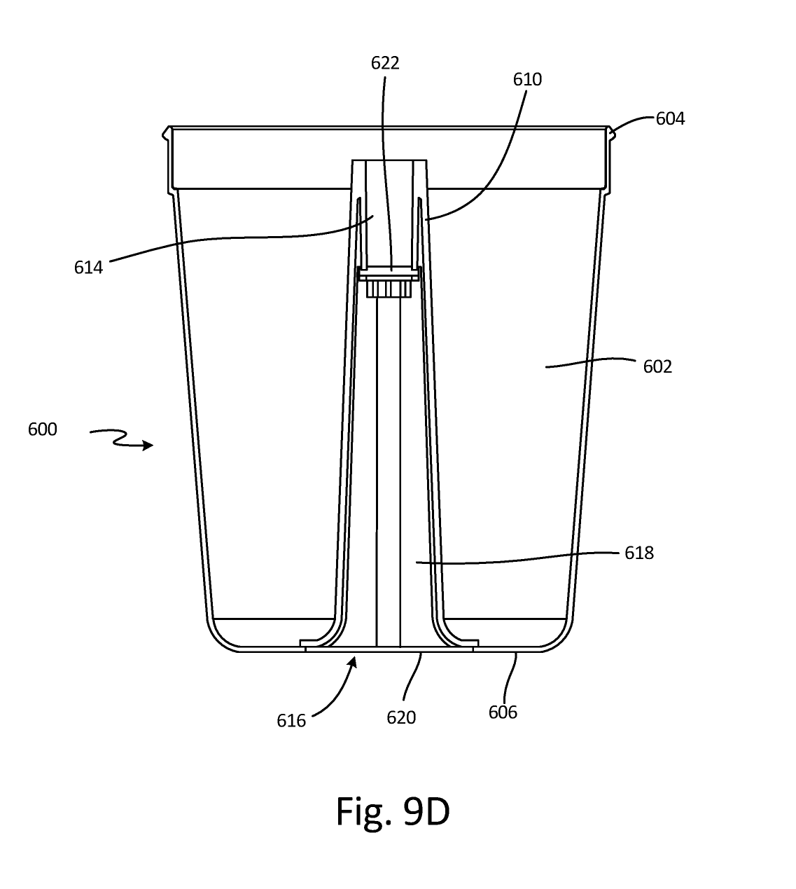

FIG. 9A is an isometric view of cup consumable 600. FIG. 9B is an exploded view of cup consumable 600. FIG. 9C is a sectioned isometric view of cup consumable 600. FIG. 9D is a cross-sectional view of cup consumable 600.

Cup consumable 600 includes cup 602, upper rim 604, bottom portion 606, bottom opening 608, center post 610, channels 612, center tube 614, filter post 616, flanges 618, bottom portion 620, and filter 622.

Cup consumable 600 can be used to prepare seeds for testing. After seeds are prepared for testing and dispensed from cup consumable 600, cup consumable 600 can be discarded. Cup consumable 600 includes cup 602 that forms a body portion of cup consumable 600. Cup 602 has upper rim 604 at an upper end of cup 602 that surrounds an opening to cup 602. Cup 602 has bottom portion 606 that is a flat bottom piece of cup 602. Bottom opening 608 is located in a center of bottom portion 606 of cup 602. Center post 610 is aligned with bottom opening 608. Center post 610 extends upward into cup 602 and channels 612 extend along center post 610. At a top end of center post 610 is center tube 614 that extends downward into center post 610.

Cup consumable 600 also includes filter post 616. Filter post 616 can be inserted through bottom opening 608 of cup 602 to be positioned in center post 610 of cup 602. Filter post 616 includes flanges 618 that extend upward from bottom portion 620. Bottom portion 620 is sized to seal against bottom opening 608 of cup 602. This allows cup 602 to hold a seed and buffer solution mixture. Flanges 618 extend upward and have a notched top that is configured to hold filter 622 at a top end of filter post 616. Flanges 618 are aligned with channels 612 in center post 610 of cup 602 so that a seed and buffer solution mixture in cup 602 can flow through channels 612 of center post 610 and around flanges 618 of filter post 616.

Filter 622 is made from a polypropylene felt material in the embodiment shown. Filter 622 is used to filter the seed and buffer solution mixture as it flows from cup 602 into filter tube 622. Polypropylene felt has absorption tendencies that help wick fluid and filter more rapidly than other filter materials. Polypropylene felt also has oil removing properties for a cleaner and better filtered mixture for DNA extraction, which leads to less background noise during testing. Other synthetic polymer materials can also be used as nonwoven felt filter media, including but are not limited to polyester, polytetrafluorethylene (commonly referred to as Teflon®), aramid, poly-paraphenylene terephthalamide (commonly referred to as Kevlar®), nylon, or rayon. Woven felt, pressed felt, and needled felt are all examples of types of materials that can also be used for filtration.

Seeds can be ground in cup consumable 600 with a seed grinder. Seeds can be added to cup 602 of cup consumable 600. Cup consumable 600 can then be positioned in a seed grinder, such as seed grinder 200 shown in FIGS. 3A-4C or seed grinder 300 shown in FIGS. 5A-5B. A shaft of a grinding mechanism can be positioned over and rotate around center post 610 of cup 602 to grind seeds in cup 602. A buffer solution can then be added to cup 602 of cup consumable 600 and mixed with the ground seeds to form a seed and buffer solution mixture. Cup consumable 600 can then be pressurized and the seed and buffer solution mixture can flow through channels 612 of center post 610 of cup 602 and around flanges 618 of filter post 616 and be forced up through filter 622 at a top end of filter post 616. Alternatively, a vacuum can be applied to cup consumable 600 to suck the seed and buffer solution mixture through channels 612 of center post 610 of cup 602 and around flanges 618 of filter post 616 and up through filter 622 at the top end of filter post 616. The seed and buffer solution mixture that passes through filter 622 can then pool in center tube 614 of center post 610 of cup 602. The seed and buffer solution mixture in center tube 614 can then be aspirated out of center tube 614 and transferred to a sample holder for testing.

### Cup Consumable 700

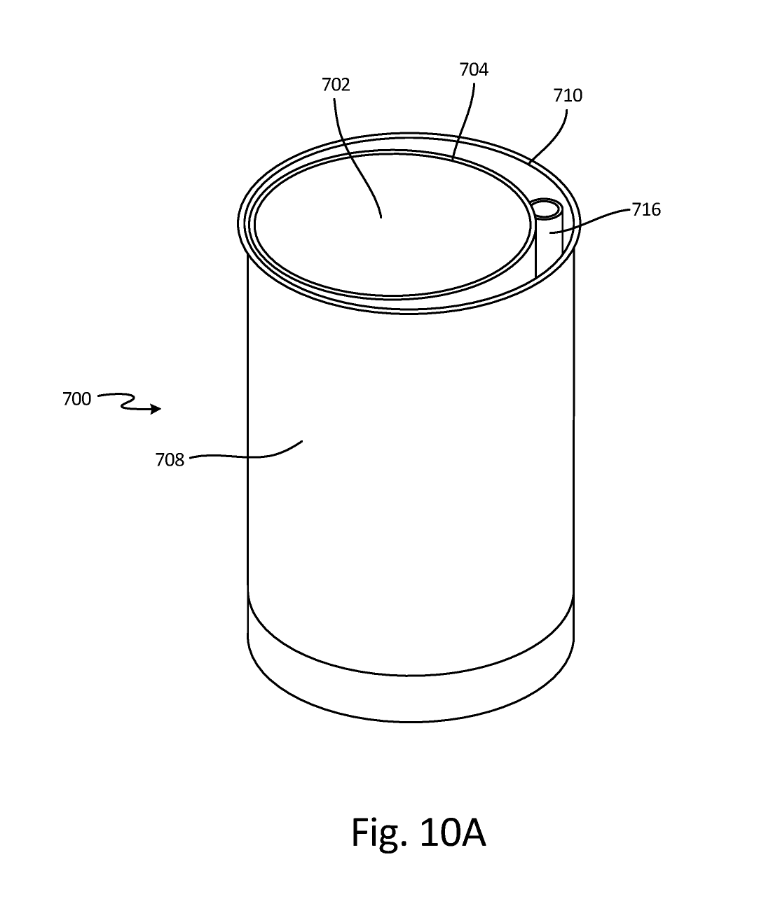

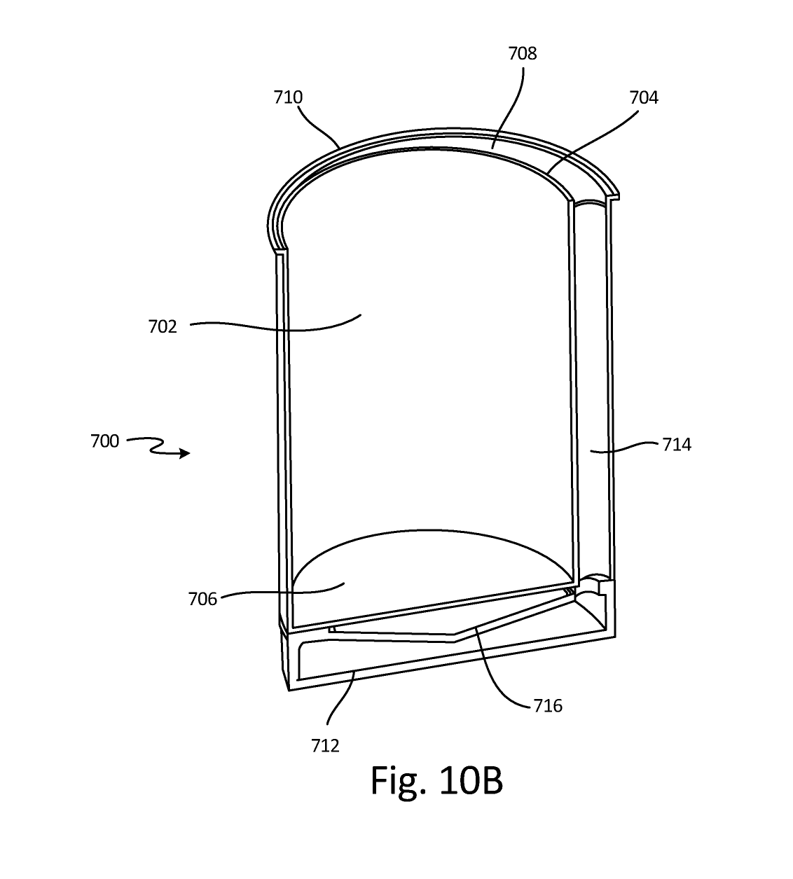

FIG. 10A is an isometric view of cup consumable 700. FIG. 10B is a sectioned isometric view of cup consumable 700.

Cup consumable 700 includes inner cup 702, upper rim 704, bottom portion 706, outer cup 708, upper rim 710, bottom portion 712, tube 714, and filter 716.

Cup consumable 700 can be used to prepare seeds for testing. After seeds are prepared for testing and dispensed from cup consumable 700, cup consumable 700 can be discarded. Cup consumable 700 includes inner cup 702. Inner cup 702 has upper rim 704 at an upper end of inner cup 702 that surrounds an opening to cup 702. Inner cup 702 has bottom portion 706 that is a flat bottom piece of inner cup 702. Cup consumable 700 also includes outer cup 708. Inner cup 702 is positioned in outer cup 708. Inner cup 702 and outer cup 708 collectively form a body portion of cup consumable 700. Outer cup 708 has upper rim 710 at an upper end of outer cup 708. Outer cup 708 has bottom portion 712 that is a flat bottom piece of outer cup 708.

Outer cup 708 also includes tube 714. Tube 714 extends up a side wall of cup consumable 700 between inner cup 702 and outer cup 708. Filter 716 is positioned between bottom portion 706 of inner cup 702 and bottom portion 712 of outer cup 708. A cavity is formed between filter 716 and bottom portion 712 of outer cup 708. Tube 714 has a first end in fluid communication with the cavity formed between filter 716 and bottom portion 712 of outer cup 708.

Seeds can be placed in inner cup 702 of cup consumable 700. Cup consumable 700 can then be positioned in a seed grinder, such as seed grinder 200 shown in FIGS. 3A-4C or seed grinder 300 shown in FIGS. 5A-5B. A grinding mechanism can then be positioned in inner cup 702 of cup consumable 700 to grind the seeds. After the seeds are ground, a buffer solution can be added to cup consumable 700 and mixed with the ground seeds to form a seed and buffer solution mixture. The grinding mechanism can then be actuated downwards to break or drill through bottom portion 706 of inner cup 702. The seed and buffer solution mixture can then flow through inner cup 702 through filter 716 into the cavity formed between filter 716 and bottom portion 712 of outer cup 708.

Filter 716 is made from a polypropylene felt material in the embodiment shown. Filter 716 is used to filter a seed and buffer solution mixture as it flows from inner cup 702 into the cavity between filter 716 and bottom portion 712 of outer cup 708. Polypropylene felt has absorption tendencies that help wick fluid and filter more rapidly than other filter materials. Polypropylene felt also has oil removing properties for a cleaner and better filtered mixture for DNA extraction, which leads to less background noise during testing. Other synthetic polymer materials can also be used as nonwoven felt filter media, including but are not limited to polyester, polytetrafluorethylene (commonly referred to as Teflon®), aramid, poly-paraphenylene terephthalamide (commonly referred to as Kevlar®), nylon, or rayon. Woven felt, pressed felt, and needled felt are all examples of types of materials that can also be used for filtration.

After the seed and buffer solution mixture has been filtered and collected in the cavity between filter 716 and bottom portion 712 of outer cup 708, cup consumable 700 can be pressurized. Pressurizing cup consumable 700 will force the seed and buffer solution mixture up through tube 714 of outer cup 708. The seed and buffer solution mixture in tube 714 can then be aspirated out of tube 714 and transferred to a sample holder for testing.

### Seed Grinder 800

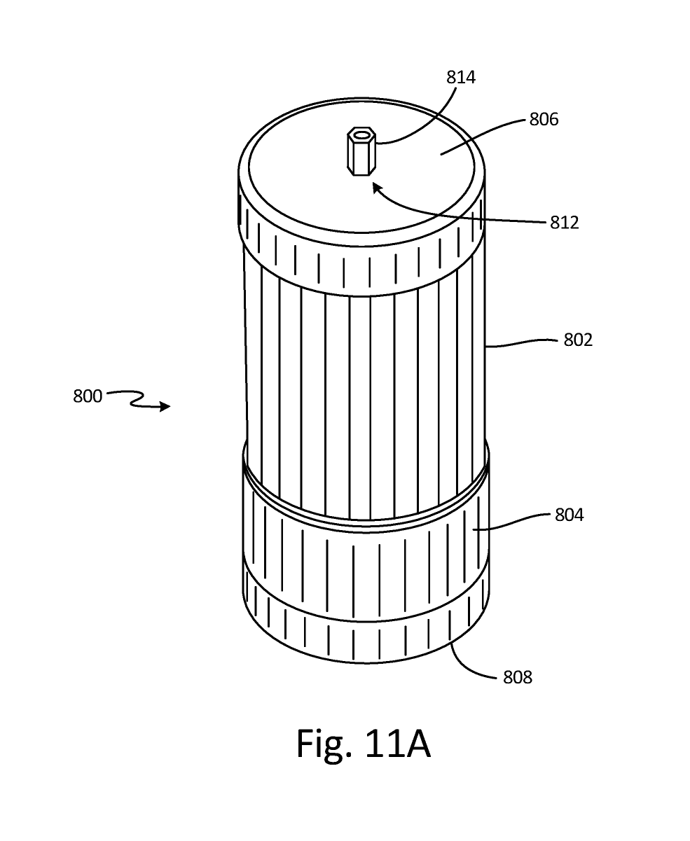

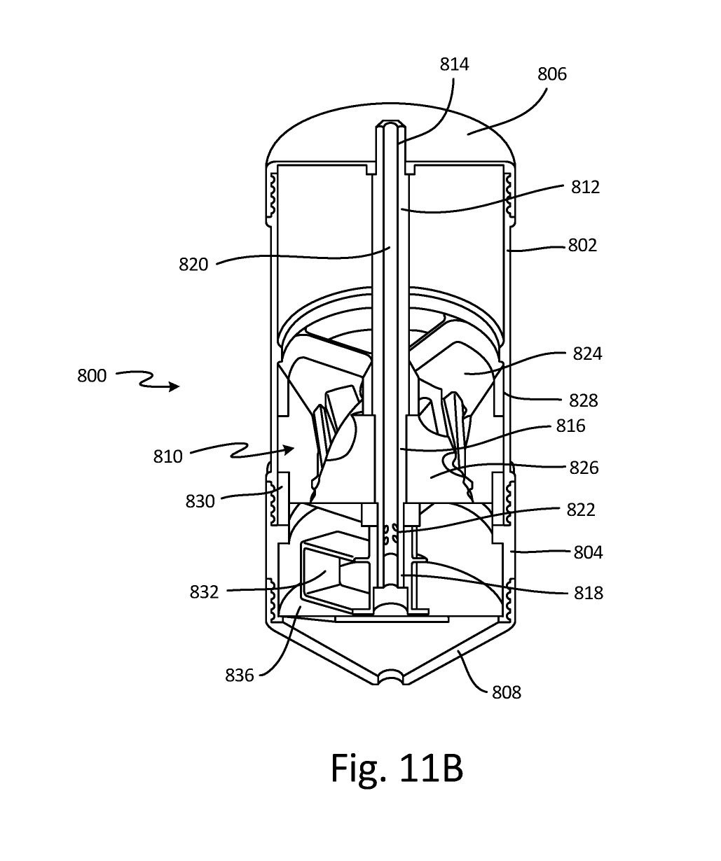

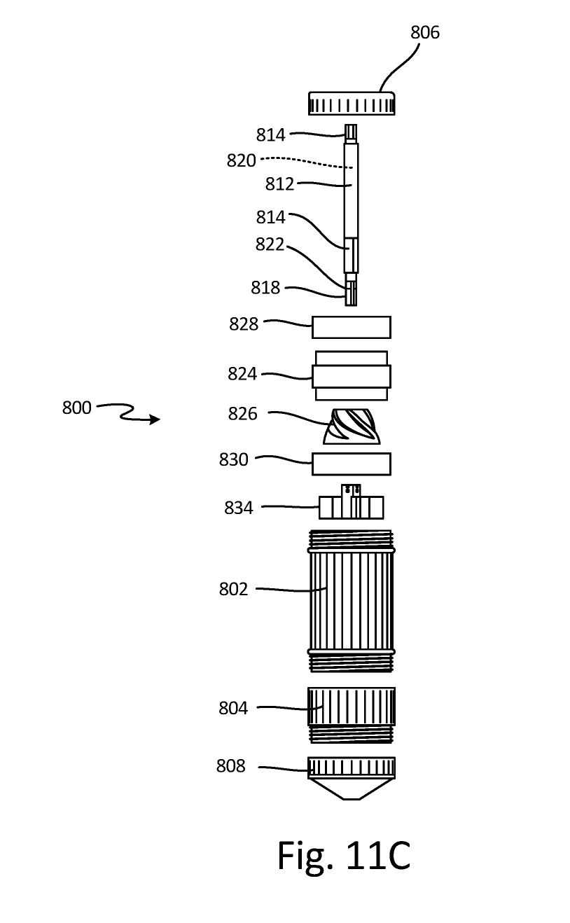

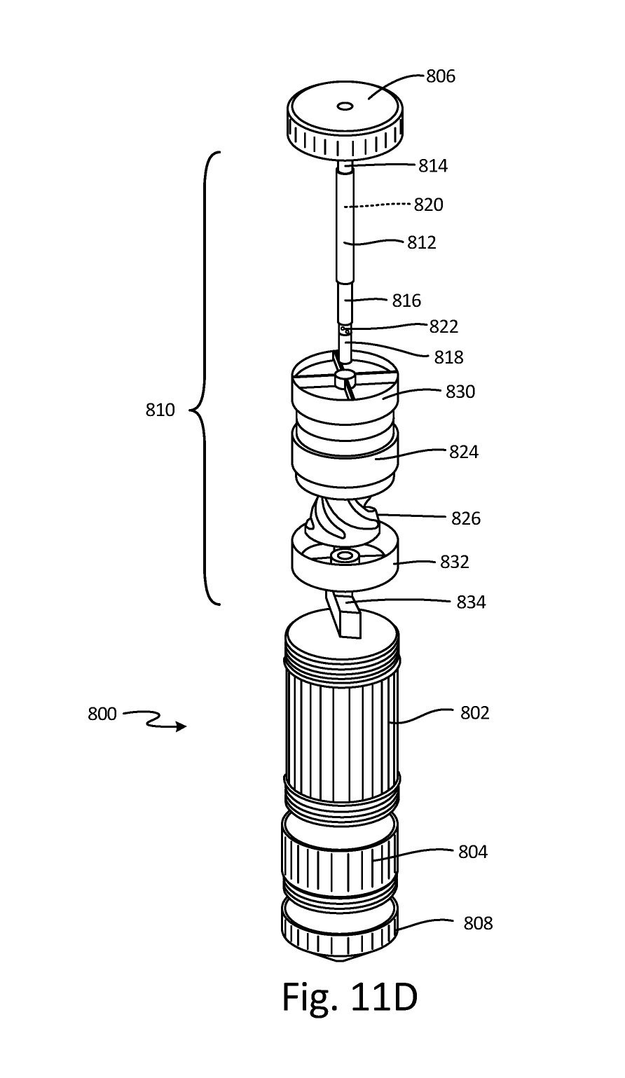

FIG. 11A is an isometric view of seed grinder 800. FIG. 11B is a sectioned isometric view of seed grinder 800. FIG. 11C is an exploded side view of seed grinder 800. FIG. 11D is an exploded isometric view of seed grinder 800.

Seed grinder 800 includes first housing portion 802, second housing portion 804, lid 806, funnel 808, grinding mechanism 810, shaft 812, motor connection portion 814, grinder connection portion 816, mixer connection portion 818, bore 820, openings 822, outer grinder 824, inner grinder 826, upper shaft support 828, lower shaft support 830, mixer 832, openings 834, and filter 836.

First housing portion 802 and second housing portion 804 form a main body portion of seed grinder 800. In the embodiment shown in FIGS. 11A-11D, a second end of first housing portion 802 is connected to a first end of second housing portion 804 by screwing them together, but they can be connected using any suitable method in alternate embodiments. Lid 806 is connected to a first end of first housing portion 802. In the embodiment shown in FIGS. 11A-11D, lid 806 is screwed onto the first end of first housing portion 802, but they can be connected using any suitable method in alternate embodiments. Funnel 808 is connected to a second end of second housing portion 804. In the embodiment shown in FIGS. 11A-11D, funnel 808 is screwed onto the second end of second housing portion 804, but they can be connected using any suitable method in alternate embodiments.

Grinding mechanism 810 is held in first housing portion 802 and second housing portion 804. Shaft 812 extends through first housing portion 802 and second housing portion 804. Shaft 812 has motor connection portion 814 at a first end that extends through an opening in lid 802 to extend out of first housing portion 802. Shaft 812 has grinder connection portion 816 and mixer connection portion 818 at a second end. Bore 820 runs from the first end to the second end of shaft 812. Openings 822 are on mixer connection portion 818 and extend from bore 820 to an exterior surface of shaft 812.

Outer grinder 824 and inner grinder 826 are positioned on grinder connection portion 816 of shaft 812. Outer grinder 824 surrounds inner grinder 826. Outer grinder 824 and inner grinder 826 are held in first housing portion 802 of seed grinder 800. Outer grinder 824 and inner grinder 826 are used to grind the contents of seed grinder 800. Upper shaft support 828 is positioned adjacent to a first end of outer grinder 824 on shaft 812. Lower shaft support 830 is positioned adjacent to a second end of inner grinder 826 on shaft 812.

Mixer 832 is positioned on mixer connection portion 818 of shaft 812. Mixer 832 includes openings 834 positioned adjacent to openings 822 in shaft 812. This allows fluids in bore 820 of shaft 812 to flow through openings 822 in shaft 812 and openings 834 in mixer 834. Mixer 832 is held in second housing portion 804 of seed grinder 800. Mixer 832 can be used to mix the contents of seed grinder 800. Filter 836 is positioned in second housing portion 804 adjacent to the second end of shaft 812. Filter 836 filters the contents of seed grinder 800 as the contents flow from second housing portion 804 to funnel 808.

Seed grinder 800 can be used to grind seeds. Lid 806 can be removed from seed grinder 800 and seeds can be scooped into first housing portion 802 of seed grinder 800. Lid 806 can then be reattached to the first end of first housing portion 802. A motor can then be attached to motor connection portion 814 of shaft 812 that extends outwards from lid 806. The motor can be activated, causing shaft 812 to rotate. As shaft 812 rotates, outer grinder 824 and inner grinder 826 will rotate with shaft 812. Outer grinder 824 and inner grinder 826 include blades that are used to grind the seeds in seed grinder 800. Outer grinder 824 and inner grinder 826 can be rotated with shaft 812 until a homogenous grind is achieved.

After the seeds have been ground, a buffer solution can be added to seed grinder 800 through bore 820 in shaft 812. The buffer solution moves from the first end of shaft 812 to the second end of shaft 812 and flows through openings 822 in shaft 812 and openings 834 in mixer 832 to enter second housing portion 814 of seed grinder 800. The motor can then be activated a second time, again causing shaft 812 to rotate. As shaft 812 rotates, mixer 832 will rotate with shaft 812. Mixer 832 will mix the ground seeds with the buffer solution to form a seed and buffer solution mixture. Mixer 832 can be rotated with shaft 812 until a desired consistency is achieved. After mixing is finished, the seed and buffer solution mixture can filter through filter 836 to move from second housing portion 804 to funnel 808. The seed and buffer solution mixture in funnel 808 is ready to be dispensed for testing.

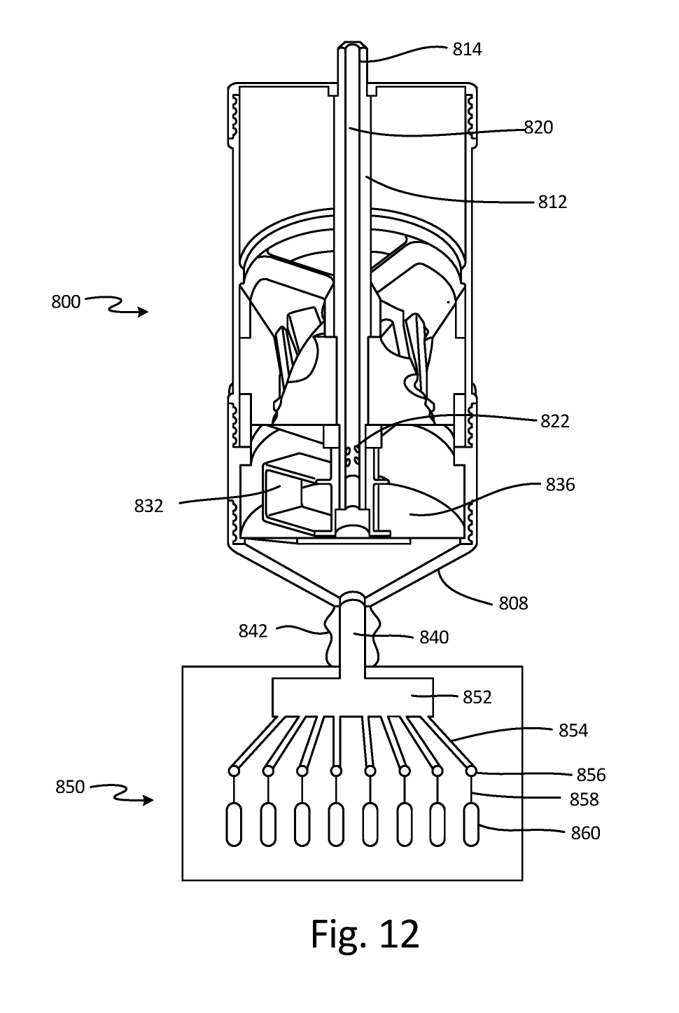

FIG. 12 is a partial sectioned isometric view of seed grinder 800 dispensing a sample into a card consumable.

FIG. 12 shows seed grinder 800, dispensing tube 840, heat source 842, and card consumable 850. Seed grinder 800 includes funnel 808, shaft 812, motor connection portion 814, bore 820, openings 822, mixer 832, openings 834 (not shown in FIG. 12), and filter 836. Card consumable 850 includes chamber 852, first channels 854, reaction chambers 856, second channels 858, and assay chambers 860.

After a seed has been ground and mixed with a buffer solution in seed grinder 800 to form a seed and buffer solution mixture, the seed and buffer solution mixture can be dispensed from seed grinder 800. An air source can be connected to motor connection portion 814 of shaft 812. Air can flow through bore 820, openings 822 in shaft 812, and openings 834 in mixer 832. This air can press the seed and buffer solution mixture through filter 836 into funnel 840. From funnel 840, the seed and buffer solution mixture will flow through dispensing tube 840 and into card consumable 850. Heat source 842 surrounds dispensing tube 840 to maintain the temperature of the seed and buffer solution mixture in dispensing tube 840.

The seed and buffer solution mixture will enter into chamber 852 of card consumable 850 from dispensing tube 840. The seed and buffer solution mixture will then flow through first channels 854 into first reaction chambers 856. In first reaction chambers 856, the seed and buffer solution mixture will mix with a reagent mixture to prepare the seed and buffer solution mixture for testing. The seed and reagent mixture will then flow through second channels 858 into assay chambers 860. When the seed and reagent mixture is in assay chambers 860, card consumable 850 can be inserted into a testing device. In the embodiment shown in FIG. 12, there are eight first channels 854, first reactions chambers 856, second channels 858, and assay chambers 860. In alternate embodiments, card consumable 850 can include any suitable number of first channels 854, first reactions chambers 856, second channels 858, and assay chambers 860. In further alternate embodiments, card consumable 850 can be a tube array, a plurality of pipettes, or a pipette tip.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A seed grinder comprising:
a housing that is configured to contain seeds and a buffer solution;
a grinding mechanism that is positionable in the housing to grind the seeds in the housing; and
a dispensing mechanism attached to the housing and configured to dispense the ground seeds and the buffer solution from the housing into a sample holder.

2. The seed grinder of claim 1, wherein the housing is a cup.

3. The seed grinder of claim 2, and further comprising:
a lid that is attachable to the cup and removed from the cup, wherein the grinding mechanism is attached to the lid.

4. The seed grinder of claim 3, wherein the grinding mechanism includes a shaft with a motor connection port at a first end and a plurality of blades at a second end.

5. The seed grinder of claim 4, wherein the shaft has a drill head at the second end.

6. The seed grinder of claim 1, wherein the dispensing mechanism includes a vacuum straw that is attached to the cup to pull the ground seeds and the buffer solution out of the cup.

7. The seed grinder of claim 6, wherein a heat source surrounds the vacuum straw.

8. The seed grinder of claim 6, wherein there is a filter positioned between the cup and the vacuum straw.

9. The seed grinder of claim 1, and further comprising:
a post;
a stationary portion attached to the post, the stationary portion comprising:
a first arm, wherein the housing is a cup that is connected for the first arm;
a second arm, wherein a washing station is connected to the second arm;
a movable portion that is attached to and movable along the post, the movable portion comprising:
a third arm, wherein the grinding mechanism is connected to the third arm; and
a fourth arm, wherein the dispensing mechanism is connected to the fourth arm; and
a motor that raises, lowers, and rotates the movable portion along the post.

10. The seed grinder of claim 9, wherein the washing station includes an opening for receiving the grinding mechanism, water jets for washing the grinding mechanism, and an air dryer for drying the grinding mechanism.

11. The seed grinder of claim 9, wherein the grinding mechanism includes a shaft with a motor attached to the shaft at the first end and a plurality of blades attached to the shaft at the second end.

12. The seed grinder of claim 11, wherein the shaft has a drill head at the second end.

13. The seed grinder of claim 11, wherein the grinding mechanism further includes a seal element that is configured to form a seal between the grinding mechanism and the cup.

14. The seed grinder of claim 9, wherein a buffer tube extends between a buffer dispenser and the grinding mechanism to deliver buffer to the cup.

15. The seed grinder of claim 9, wherein the dispensing mechanism includes a seal element that is configured to form a seal between the dispensing mechanism and the cup.

16. The seed grinder of claim 15, wherein an air tube extends between an air pressure source and a tube to provide air to the cup.

17. The seed grinder of claim 9, wherein a dispensing tube is extends between a dispensing port in the cup and the consumable.

18. The seed grinder of claim 17, wherein a filter is positioned between the cup and the dispensing port.

19. The seed grinder of claim 17, wherein a filter is positioned in line with the dispensing tube.

20. The seed grinder of claim 17, wherein a filter is attached to a shaft that be extended through the cup.

21. The seed grinder of claim 1, wherein the housing further comprising:
a first housing portion;
a lid that is attachable to a first end of the first housing portion;
a second housing portion that is attached to a second end of the first housing portion; and
a funnel that is attachable to a second end of the second housing portion.

22. The seed grinder of claim 21, wherein the grinding mechanism is positioned in the first housing portion and the second housing portion and extends through the lid.

23. The seed grinder of claim 22, wherein the grinding mechanism includes a shaft with a motor connection portion at a first end of the shaft and a grinder connection portion and a mixer connection portion at a second end of the shaft.

24. The seed grinder of claim 23, wherein an outer grinder and an inner grinder are connected to the grinder connection portion of the shaft.

25. The seed grinder of claim 23, wherein a mixer is connected to the mixer connection portion of the shaft.

26. The seed grinder of claim 23, wherein a bore extends through the shaft and there are openings on the mixer connection portion of the shaft.

27. The seed grinder of claim 21, wherein a filter is positioned between the second housing portion and the funnel.

28. The seed grinder of claim 21, wherein a dispensing tube extends between the funnel and the consumable.

29. The seed grinder of claim 28, wherein a heat source surrounds the dispensing tube.

30. The seed grinder of claim 1, wherein the consumable comprises a card, a single tube, a tube array, a micro plate, a profile belt, a tape, a pipette tip, or a plurality of pipettes.

31. A method of grinding and dispensing seeds from a seed grinder, the method comprising:
collecting seeds in a housing of a seed grinder;
grinding the seeds in the housing until a homogenous seed grind is achieved;
adding a buffer solution to the housing;
mixing the buffer solution with the ground seeds to form a seed and buffer solution; and
dispensing the seed and buffer solution into a consumable with a dispensing tube that extends between the housing and the consumable.

32. The method of claim 31, and further comprising:
attaching a lid with a grinding mechanism to the housing;
connecting a motor to a motor connection port of the grinding mechanism;
rotating a shaft of the grinding mechanism to rotate blades that are attached to the shaft;
actuating the shaft of the grinding mechanism through the housing to puncture a filter in the housing; and
filtering the seed and buffer solution.

33. The method of claim 31, and further comprising:
positioning a grinding mechanism in the housing, wherein the grinding mechanism is attached to a first arm that is movable along a post;
removing the grinding mechanism from the housing;
positioning the grinding mechanism in a washing station;
washing the grinding mechanism using water jets positioned in the washing station;
drying the grinding mechanism using air dryers positioned in the washing station;
positioning a dispensing mechanism in the housing, wherein the dispensing mechanism is attached to a second arm that is movable along the post;
blowing air into the housing to push the seed and buffer solution out of the housing and into a dispensing tube; and
filtering the seed and buffer solution.

34. The method of claim 31, and further comprising:
connecting an air source to a shaft of the grinding mechanism, wherein there is a bore extending through the shaft;
blowing air into the housing through the bore and openings in the shaft of the grinding mechanism;
filtering the seed and buffer solution; and
moving the seed and buffer solution out of the housing and into a dispensing tube.

35. A seed grinder comprising:
a cup that is capable of containing seeds and a buffer solution;
a first grinding mechanism that is positionable in the cup to grind the seeds in the cup; and
a second grinding mechanism that is positionable in the cup to grind the seeds in the cup.

36. The seed grinder of claim 35, and further comprising:
a post;
a stationary portion attached to the post, the stationary portion comprising:
a first arm, wherein the cup is connected to the first arm;
a second arm, wherein a washing station is connected to the second arm;
a movable portion that is attached to and movable along the post, the movable portion comprising:
a third arm, wherein the first grinding mechanism is connected to the third arm; and
a fourth arm, wherein the second grinding mechanism is connected to the fourth arm; and
a motor that raises, lowers, and rotates the movable portion along the post.

37. The seed grinder of claim 36, wherein in a first operating position, the first grinding mechanism is positioned in the cup and the second grinding mechanism is positioned in the washing station.

38. The seed grinder of claim 37, wherein in a second operating position, the second grinding mechanism is positioned in the cup and the first grinding mechanism is positioned in the washing station.

39. The seed grinder of claim 36, wherein the washing station further comprises:
an opening for receiving the first grinding mechanism or the second grinding mechanism;
water jets for washing the first grinding mechanism or the second grinding mechanism;
a drain for draining water out of the washing mechanism; and
an air dryer for drying the first grinding mechanism or the second grinding mechanism.

40. The seed grinder of claim 36, wherein the first grinding mechanism further comprises:
a shaft;
a motor attached to a first end of the shaft;
a seal element surrounding the shaft adjacent to the motor on the first end of the shaft;
a plurality of blades attached to a second end of the shaft; and
a drill head at the second end of the shaft.

41. The seed grinder of claim 40, wherein the seal element of the first grinding mechanism is configured to form a seal between the first grinding mechanism and the cup.

42. The seed grinding of claim 40, and further comprising:
a buffer port extending through the motor and the seal element of the first grinding mechanism; and
an air and water port extending through the motor and the seal element of the first grinding mechanism.

43. The seed grinder of claim 42, wherein the second grinding mechanism further comprises:
a shaft;
a motor attached to a first end of the shaft;
a seal element surrounding the shaft adjacent to the motor on the first end of the shaft;
a plurality of blades attached to a second end of the shaft; and
a drill head at the second end of the shaft.

44. The seed grinder of claim 43, wherein the seal element of the second grinding mechanism is configured to form a seal between the second grinding mechanism and the cup.

45. The seed grinding of claim 43, and further comprising:
a buffer port extending through the motor and the seal element of the second grinding mechanism; and
an air and water port extending through the motor and the seal element of the second grinding mechanism.

46. The seed grinder of claim 45, and further comprising:
a buffer dispenser;
a first buffer tube with a first end connected to the buffer dispenser and a second end connected to the buffer port of the first grinding mechanism; and
a second buffer tube with a first end connected to the buffer dispenser and a second end connected to the buffer port of the second grinding mechanism.

47. The seed grinder of claim 45, and further comprising:
an air and water source;
a first air and water tube with a first end connected to the air and water source and a second end connected to the air and water port of the first grinding mechanism; and
a second air and water tube with a first end connected to the air and water source and a second end connected to the air and water port of the second grinding mechanism.

48. A cup consumable comprising:
a cup with an upper rim and a bottom rim;
a filter housing with an upper rim and a bottom rim, wherein the upper rim of the filter housing is connected to a bottom rim of the cup; and
an aspirate cup with an upper rim, wherein the upper rim of the aspirate cup is connected to a bottom rim of the filter housing.

49. The cup consumable of claim 48, wherein the cup further has a bottom portion positioned between the upper rim and bottom rim.

50. The cup consumable of claim 49, wherein the bottom portion of the cup has a raised center portion.

51. The cup consumable of claim 49, wherein the filter housing further has a sloped body portion between the upper rim and the bottom rim.

52. The cup consumable of claim 51, and further comprising:
a filter positioned between the bottom portion of the cup and the sloped body portion of the filter housing.

53. The cup consumable of claim 52, wherein the filter is compressed between the bottom portion of the cup and the sloped body portion of the filter housing.

54. The cup consumable of claim 52, wherein the filter is made out of a polypropylene felt material.

55. The cup consumable of claim 48, wherein the aspirate cup is configured to be removable from the filter housing.

56. A cup consumable comprising:
a cup with an upper rim and a bottom rim;
a lid with a body portion extending between an outer rim and a center cylinder, wherein the outer rim of the lid engages the upper rim of the cup.

57. The cup consumable of claim 56, and further comprising:
a filter tube with an upper lip and a bottom portion; and
a filter positioned adjacent to the bottom portion of the filter tube.

58. The cup consumable of claim 57, wherein the filter tube and the filter are positioned in the center cylinder of the lid.

59. The cup consumable of claim 57, wherein the filter is made out of a polypropylene felt material.

60. A cup consumable comprising:
a cup with an upper rim, a bottom portion, and a center post extending upward into an interior of the cup from an opening in the bottom portion; and
a filter post that is positioned in the center post of the cup.

61. The cup consumable of claim 60, wherein the center post of the cup has channels extending along the center post.

62. The cup consumable of claim 61, wherein the channels in the center post are configured to allow fluid to flow through the channels.

63. The cup consumable of claim 60, wherein the filter post further comprises:
a base portion that forms a seal with the opening in the bottom portion of the cup; and
flanges extending upwards from the base portion.

64. The cup consumable of claim 63, and further comprising:
a filter held in a notch created by the flanges of the filter post.

65. The cup consumable of claim 64, wherein the filter is made out of a polypropylene felt material.

66. A cup consumable comprising:
an inner cup with an upper rim and a bottom portion; and
an outer cup with an upper rim and a bottom portion, wherein the inner cup is positioned in the outer cup; and a
a tube extending between the inner cup and the outer cup.

67. The cup consumable of claim 66, wherein a cavity is formed between the bottom portion of the inner cup and the bottom portion of the outer cup.

68. The cup consumable of claim 67, wherein a first end of the tube is connected to the cavity formed between the bottom portion of the inner cup and the bottom portion of the outer cup and a second end of the tube is adjacent to the upper rim of the inner cup and the upper rim of the outer cup.

69. The cup consumable of claim 67, wherein a filter is positioned in the cavity formed between the bottom portion of the inner cup and the bottom portion of the outer cup.

70. The cup consumable of claim 69, wherein the filter is made out of a polypropylene felt material.

71. A method of grinding and dispensing seeds from a seed grinder, the method comprising:
collecting seeds in a cup;
positioning the cup in a seed grinder;
grinding the seeds in the cup with a first grinding mechanism until a homogenous seed grind is achieved;
adding a buffer solution to the housing; and
mixing the buffer solution with the ground seeds to form a seed and buffer solution mixture.

72. The method of claim 71, and further comprising:
positioning the first grinding mechanism in the cup and a second grinding mechanism in a washing station;
washing the second grinding mechanism in the washing station;
removing the first grinding mechanism from the cup and the second grinding mechanism from the washing station;
positioning the first grinding mechanism in the washing station and the second grinding mechanism in the cup;
grinding the seeds in the cup with a second grinding mechanism until a homogenous seed grind is achieved;
washing the first grinding mechanism in the washing station; and
removing the first grinding mechanism from the washing station and the second grinding mechanism from the cup.

73. The method of claim 72, wherein grinding the seeds with a first grinding mechanism further comprises:
rotating a shaft of the first grinding mechanism, wherein blades are attached to a first end of the shaft;
breaking up the seeds in the cup as the blades rotate through the cup.

74. The method of claim 72, wherein grinding the seeds with a first grinding mechanism further comprises:
rotating a shaft of the second grinding mechanism, wherein blades are attached to a first end of the shaft;
breaking up the seeds in the cup as the blades rotate through the cup.

75. The method of claim 72, wherein washing the second grinding mechanism in the washing station further comprises:
spraying water from water jets positioned in the washing station towards the second grinding mechanism;
draining the water from the washing station out through a drain; and
drying the second grinding mechanism using an air dryer positioned in the washing station.

76. The method of claim 72, wherein washing the first grinding mechanism in the washing station further comprises:
spraying water from water jets positioned in the washing station towards the first grinding mechanism;
draining the water from the washing station out through a drain; and
drying the first grinding mechanism using an air dryer positioned in the washing station.

77. The method of claim 72, and further comprising:
dispensing a buffer solution through the first grinding mechanism and into the cup; and
mixing the buffer solution with the ground seeds to form a seed and buffer solution mixture.

78. The method of claim 77, and further comprising:
actuating the first grinding mechanism downwards so that a drill head on an end of the first grinding mechanism punctures a bottom of the cup; and
dispensing the seed and buffer solution mixture from the cup.

79. The method of claim 72, and further comprising:
dispensing a buffer solution through the second grinding mechanism and into the cup; and
mixing the buffer solution with the ground seeds to form a seed and buffer solution mixture.

80. The method of claim 79, and further comprising:
actuating the second grinding mechanism downwards so that a drill head on an end of the second grinding mechanism punctures a bottom of the cup; and
dispensing the seed and buffer solution mixture from the cup.
